(19) United States
(12) Patent Application Publication
(10) Pub. No.: US 2026/0274123 A1
(43) Pub. Date: Sep. 17, 2026

(54) SUPPORTING LEG ASSEMBLY, SUPPORTING LEG TELESCOPIC MECHANISM AND CARRIER

(71) Applicant: WONDERLAND SWITZERLAND AG, Steinhausen (CH)

(72) Inventors: Xiaolong MO, Dongguan, Guangdong (CN); Kun ZHANG, Dongguan, Guangdong (CN); Ruyi LI, Dongguan, Guangdong (CN)

(73) Assignee: WONDERLAND SWITZERLAND AG, Steinhausen (CH)

(21) Appl. No.: 19/168,703

(22) PCT Filed: Mar. 28, 2024
(86) PCT No.: PCT/EP2024/058511

§ 371 Date: Sep. 24, 2025

(30) Foreign Application Priority Data
Mar. 30, 2023 (CN) 202310332942.9
Apr. 24, 2023 (CN) 202310453432.7
Jun. 1, 2023 (CN) 202310647207.7
Mar. 11, 2024 (CN) 202410274975.7

(51) Int. Cl. B60N 2/28; B60N 2/26; F16B 7/10

(52) U.S. Cl. CPC B60N 2/2824; B60N 2/268; F16B 7/105

(57) ABSTRACT

The present disclosure discloses a supporting leg assembly, which includes: an indicator, disposed at the indicating end and capable of moving between a first position and a second position, so as to indicate whether the supporting leg contacts a surface; a driving element, movably disposed in the contacting end; a traction element, including a first end of the traction element connected to the indicator and a second end of the traction element connected to the contacting end; a holding sleeve, sleeved on the traction element and prevents at least a part of the traction element from bending; when the contacting end contacts the surface, the driving element driving the traction element to slide relative to the holding sleeve, and the traction element further driving the indicator. The present disclosure also discloses a supporting leg and a carrier.

This application is a U.S. National Stage application of PCT/EP2024/058511, filed on Mar. 28, 2024, which claims the benefit of Chinese Application No. 202310332942.9, filed on Mar. 30, 2023, Chinese Application No. 202310453432.7, filed on Apr. 24, 2023, Chinese Application No. 202310647207.7, filed on Jun. 1, 2023 and Chinese Application No. 202410274975.7, filed on Mar. 11, 2024, all of which are incorporated herein by reference in their entirety.

### TECHNICAL FIELD

The present disclosure relates to a supporting leg assembly, a supporting leg telescopic mechanism, an anti-pinch hand rotating mechanism, a supporting leg having a contact indicating mechanism, and a carrier having the supporting leg.

### BACKGROUND

Generally, a child safety seat is provided with a supporting leg in front of a base of the seat. One end of the supporting leg is fixed to the base of the child safety seat, and the other end of the supporting leg is supported on a floor of a vehicle, so that the child safety seat is more stably installed. However, if the supporting leg fails to stably contact with the ground, the child safety seat may have a risk of being overturned. Therefore, during use of the supporting leg, it is necessary to ensure that the supporting leg contacts with the ground.

At present, the supporting leg on the market may be retractable and folded with respect to the base, however, the supporting leg cannot indicate a user whether the supporting leg is placed securely, causing a potential safety hazard of being misused under the condition that the supporting leg is not completely extended and does not stably contact with the ground.

In the supporting leg, an internal cable is used to transmit a movement that a contacting end of the supporting leg contacts with the ground to an indicator of an indicating end, so that the indicator can provide a contacting indication. In such a mechanism, with the retraction or folding of the supporting leg, the cable will also be wound or folded. There is a problem that when the supporting leg is retracted or folded, a wound part of the cable may be close to the contacting end due to factors such as the gravity of the cable. In this way, the contacting end will directly abut against the wound part, resulting in abnormal winding of the cable, and even resulting in the cable directly abutting against the indicator, thus affecting the normal use of the supporting leg.

Therefore, there is a need to provide a supporting leg that can assist a proper winding of the cable, particularly assist a proper positioning of the wound part of the cable.

The child safety seat has become a necessary carrier for infants or children to travel in various vehicles. At present, there is a child safety seat that has a supporting leg for being supported on a ground in a vehicle compartment. The supporting leg can perform a pivoting movement and a telescopic movement. In order to facilitate the opening of the supporting leg, the child safety seat may be provided with an automatic pop-up structure, so that the user can conveniently actuate the supporting leg to be unfolded and contact the ground when in use. However, when the supporting leg is unfolded, due to the automatic pop-up structure, a force for pivoting and extending of the supporting leg may be large, and thus causing noise, which will reduce the user's experience. At the same time, when the user shows or uses the child safety seat, if the supporting leg is improperly pivotally connected to a specific angle or extended to a specific position, there will be a probability of colliding with people around, so there is a certain safety hazard.

Therefore, there is a need for a child safety seat with an unfolding speed of the supporting leg to be controlled.

The child safety seat is a device that is installed on a vehicle seat and restrains a child on the child safety seat by a safety belt. In case of emergency braking or collision of the vehicle, the child safety seat can effectively prevent the child from moving rapidly, to avoid secondary collision and reduce harm to the child, provide a strong protection and restraint for the child, and ensure the riding safety of the child.

The supporting leg of some existing child safety seats is not retractable or has a small telescopic stroke, which leads to a large packaging volume, and will reduce the loading quantity of the child safety seat in a container and increase the transportation cost. In addition, even if the supporting leg of some existing child safety seats can be retractable, a length of a sliding frame is long, which leads to the high material cost of the sliding frame.

### SUMMARY

A supporting leg assembly according to the present disclosure is used for a child carrier, and includes: a supporting leg of which is capable of extending and retracting and a contact indicating mechanism; wherein, the supporting leg has an indicating end and a contacting end that are opposite to each other, and the contact indicating mechanism includes: an indicator, disposed at the indicating end and capable of moving between a first position and a second position, thereby indicating whether the supporting leg contacts a surface; a driving element, movably disposed in the contacting end; a traction element, including a first end of the traction element connected to the indicator and a second end of the traction element connected to the contacting end; a holding sleeve, sleeved on the first end of the traction element and prevents a part of the traction element from bending; wherein when the contacting end contacts the surface, the driving element drives the traction element to slide relative to the holding sleeve, and the traction element further drives the indicator.

In one embodiment, the holding sleeve is disposed close to the second end of the traction element.

In one embodiment, the driving element is at least partially exposed from the contacting end and includes a contacting portion extending to an external of the contacting end.

In one embodiment, a second elastic element is disposed between the driving element and the contacting end, and the second elastic element biases the driving element towards the extended position.

In one embodiment, the driving element includes a shoulder extending generally transversely, and two contacting portions extend out of the contacting end in a vertical direction from two transverse ends of the shoulder respectively. The shoulder is provided with a column hole, and the column hole can be sleeved on a column at the bottom of the contacting end, and the second elastic element is sleeved on the column. The second elastic element is disposed between the column and the shoulder to bias the driving element towards the extended position.

In one embodiment, the driving element further includes a second accommodating portion. The second accommodating portion extends vertically inward from a center of the shoulder in a form of a groove and has a shape corresponding to a second end of the holding sleeve to fix the second end of the holding sleeve.

In one embodiment, the indicating end further includes a first elastic element abutting against the indicator to bias the indicator towards the first position.

In one embodiment, a first side of the indicator has a first accommodating portion for accommodating the first end of the traction element, a second side of the indicator abuts against an end of the first elastic element, and the other end of the first elastic element is fixed to the indicating end, wherein the first side is opposite to the second side.

In one embodiment, the indicating end is provided with a movable shaft or a slide rail, and the indicator rotates between the first position and the second position through the movable shaft or slides between the first position and the second position through the slide rail.

In one embodiment, the indicator includes a first area and a second area. When the contact indicating mechanism is not in contact with the surface, the indicator is in the first position, and the first area is exposed from a hollow portion or a transparent window of the contact indicating mechanism. When the contact indicating mechanism is in contact with the surface, the indicator is in the second position, and the second area is exposed from the hollow portion or the transparent window. The first area and the second area have different visual effects.

In one embodiment, the traction element is a steel wire.

A supporting leg according to the present disclosure includes the contact indicating mechanism, and the supporting leg has a length that can be changed.

In one embodiment, the contact indicating mechanism is provided with a limiting portion. The limiting portion is disposed to keep a distance between the limiting portion and the indicating end substantially unchanged when the supporting leg changes its length, and the traction element bypasses the limiting portion.

In one embodiment, a winding section of a traction element sleeve sleeved on the outside the traction element bypasses the limiting portion, and a distance between the winding section and the indicating end is substantially unchanged when the supporting leg changes its length.

In one embodiment, the supporting leg further includes: a first tube, close to the indicating end; a second tube, close to the contacting end and capable of sliding relative to the first tube to adjust the length of the supporting leg. The limiting portion is disposed inside the first tube and at an end of the first tube away from the indicating end.

A carrier according to the present disclosure includes: a base; a seat carried by the base. According to the supporting leg of the present disclosure, the supporting leg is installed under the base for supporting the base.

A carrier according to the present disclosure includes: a base; a supporting leg, pivotally connected to the base and capable of pivoting relative to the base; and a first buffer mechanism, disposed between the base and the supporting leg and capable of contacting at least one of the base and the supporting leg, wherein the first buffer mechanism is formed to provide resistance to a pivoting movement of the supporting leg relative to the base.

A carrier according to the present disclosure includes: a base; a movable bracket, slidably connected to the base; a supporting leg, connected to the movable bracket; and a second buffer mechanism, disposed between the base and the movable bracket and capable of contacting at least one of the base and the movable bracket; wherein, the second buffer mechanism is formed to provide resistance to sliding of the movable bracket relative to the base.

In one embodiment, the carrier further includes a restoring element. The restoring element is connected to the movable bracket and can bias the movable bracket to a sliding direction away from the base.

In one embodiment, the movable bracket can slide between an extended position and a retracted position, and the second buffer mechanism provides resistance to a part of a moving path of the movable bracket from the retracted position to the extended position.

In one embodiment, the base includes a fixing bracket, and the second buffer mechanism includes a locking element, wherein the fixing bracket is fixed in the base housing of the base, the movable bracket is slidably disposed on the fixing bracket, and the locking element is protrudingly disposed on the movable bracket.

In one embodiment, the locking element includes a locking seat, a locking pin and a driving element, wherein the locking pin can be telescopically disposed inside the locking seat and abuts against the fixing bracket, and the driving element is disposed inside the locking seat to exert a thrust force on the locking pin towards the fixing bracket.

In one embodiment, a groove is formed on the fixing bracket, and the locking pin abuts against the groove during the process of the movable bracket sliding relative to the fixing bracket.

In one embodiment, a locking hole is formed on the fixing bracket, and the locking hole is spaced from the groove. The locking pin is located in the locking hole when the supporting leg is in the extended position.

In one embodiment, the second buffer mechanism includes a buffer element. An end of the buffer element is fixed in the base housing, and the buffer element can abut against the locking element to provide resistance to a part of a moving path of the supporting leg from the retracted position to the extended position.

In one embodiment, the buffer element is formed as an elastic sheet, and the elastic sheet is formed with a protrusion for abutting against the locking seat.

In one embodiment, the protrusion includes a first surface and a second surface connecting the first surface, and an included angle between the second surface and the horizontal direction is greater than an included angle between the first surface and the horizontal direction; wherein, when the locking element abuts against the first surface, the buffer element applies a thrust force in a direction towards the retracted position to the locking element; and when the locking element abuts against the second surface, the buffer element applies a thrust force in a direction towards the extended position to the locking element.

In one embodiment, the second buffer mechanism includes a buffer element. An end of the buffer element is fixed to the movable bracket, and the other end of the buffer element is a free end. The free end partially abuts against the base housing to provide resistance to a movement of the movable bracket from the retracted position to the extended position.

In one embodiment, when the movable bracket is in the extended position, the buffer element does not abut against the base housing.

In one embodiment, the free end of the buffer element extends upward and in the direction towards the extended position.

In one embodiment, the free end of the buffer element is formed as an arc surface.

In one embodiment, an inner side of the base housing is formed with a blocking concave portion and a blocking protrusion which are adjacent to each other. The free end of the buffer element sequentially abuts against the blocking concave portion and the blocking protrusion in the process of the movable bracket moving from the retracted position to the extended position, thereby being subjected to increased resistance.

In one embodiment, during the movement of the movable bracket from the retracted position to the extended position, the free end of the buffer element is not in contact with the base housing after the free end of the buffer element no longer abuts against the blocking protrusion.

In one embodiment, an accommodating portion is formed at the bottom of the base for lockably accommodating the supporting leg.

In one embodiment, the base housing of the base is provided with a locking button. The locking button can be actuated to lock the supporting leg in the accommodating portion, and in an initial state of the carrier, the locking button does not lock the supporting leg.

A carrier according to the present disclosure includes: a base, having a fixing bracket; a movable bracket, slidably connected to the fixing bracket; a supporting leg, connected to the movable bracket; a first buffer mechanism, disposed between the movable bracket and the supporting leg and capable of contacting at least one of the movable bracket and the supporting leg; a second buffer mechanism, disposed between the base and the movable bracket and capable of contacting at least one of the base and the movable bracket; and a restoring element, connected to the movable bracket and capable of biasing the movable bracket to a sliding direction away from the base, wherein the supporting leg is capable of pivoting between a folded position and an unfolded position, and the first buffer mechanism includes a buffer portion, wherein the first buffer portion provides resistance to a part of a pivoting path of the supporting leg from the folded position to the unfolded position; and the movable bracket is capable of sliding between an extended position and a retracted position, and the second buffer mechanism provides resistance to a part of a moving path of the movable bracket from the retracted position to the extended position.

A supporting leg telescopic mechanism according to the present disclosure is suitable for a carrier and includes: a supporting leg; a first sliding frame, connected to a body of the carrier; a second sliding frame, connected to the supporting leg; and a connecting element, movably connected to the first sliding frame and the second sliding frame respectively, wherein the first sliding frame and the second sliding frame are in sliding fit with each other through the connecting element to adjust a spacing length between the supporting leg and the body. An adjustable spacing length range between the body and the supporting leg relative to each other is greater than a length of the first sliding frame or the second sliding frame in a sliding direction.

In one embodiment, when the first sliding frame and the second sliding frame slide relative to each other, the sliding pin can be located at any position of an overlapping part of the first sliding frame and the second sliding frame. The adjustable spacing length range between the body and the supporting leg is greater than a length of either a first sliding groove or a second sliding groove in the sliding direction.

In one embodiment, the connecting element is slidably connected to the first sliding frame and the second sliding frame respectively. When the supporting leg telescopic mechanism is switched from the retracted state to the extended state, a sliding direction of the connecting element relative to the first sliding frame is opposite to a sliding direction of the connecting element relative to the second sliding frame.

In one embodiment, the locking element includes an elastic element, and an elastic force of the elastic element biases the locking protrusion towards a direction of the locking hole.

In one embodiment, the locking protrusion and the unlocking portion are formed as a one-piece body.

In one embodiment, a first end of the one-piece body is the unlocking portion. The unlocking portion is formed as an unlocking button. A second end of the one-piece body opposite to the first end is formed as the locking protrusion. The one-piece body is pivotally connected to the second sliding frame or the first sliding frame, so that when the unlocking portion is pressed, the locking protrusion releases cooperation with at least one of the first locking hole and the second locking hole.

In one embodiment, the second sliding frame is sleeved inside the first sliding frame and can slide along the first sliding frame.

An anti-pinch hand rotating mechanism according to the present disclosure is suitable for a child safety seat. The child safety seat includes a body and a supporting leg, and the body is provided with a connecting portion pivotally connected to the supporting leg. The supporting leg has an unfolded position away from the body and a folded position close to the body. The anti-pinch hand rotating mechanism includes: an anti-pinch cover, pivotally connected to the connecting portion; and a mounting seat, fixedly connected to the supporting leg. When the supporting leg pivots from the extended state to the folded state, the mounting seat drives the anti-pinch cover to rotate to cover a gap between the supporting leg and the connecting portion.

In one embodiment, the mounting seat is provided with a contact bar, and the anti-pinch cover is provided with a step portion. The contact bar protrudes from the supporting leg. When the supporting leg pivots from the unfolded position to the folded position, the contact bar pulls the step portion of the anti-pinch cover, so that the anti-pinch cover pivots with the supporting leg.

In one embodiment, the mounting seat is provided with a limiting hook, and the connecting portion is provided with a clamping groove. After the supporting leg is unfolded in place, the limiting hook is clamped with the clamping groove to limit the supporting leg in the extended position.

In one embodiment, the mounting seat is movably matched with the anti-pinch cover, and there is an intermediate position between the unfolded position and the folded position. In the process of the supporting leg pivoting from the unfolded position to the intermediate position, the contact bar does not abut against the step portion. In the process of the supporting leg pivoting from the intermediate position to the folded position, the contact bar abuts against the step portion.

In one embodiment, when the supporting leg pivots from the folded position to the unfolded position, the supporting leg pushes the step portion of the anti-pinch cover, so that the anti-pinch cover pivots with the supporting leg.

In one embodiment, a decorative cover is included. The decorative cover is disposed on the connecting portion, and an accommodating space for accommodating the anti-pinch cover is formed between the decorative cover and the connecting portion as well as the supporting leg, and the anti-pinch cover is accommodated in the accommodating space when the supporting leg is in the unfolded position.

In one embodiment, the anti-pinch cover and the supporting leg is pivotally connected to a same pivot shaft. The pivot shaft deviates from an extending line of a length direction of the supporting leg. A ground contacting indicator is pivotally connected to the mounting seat, and the connecting portion is provided with an indicator through hole. When the supporting leg is in the unfolded position, the ground contacting indicator is aligned with the indicator through hole.

A carrier according to the present disclosure includes a body and a supporting leg. The body is provided with the supporting leg telescopic mechanism according to the present disclosure, and the pivot position between the supporting leg and the body is provided with the anti-pinch hand rotating mechanism according to the present disclosure.

### BRIEF DESCRIPTION OF THE DRAWINGS

Embodiments of the present disclosure will be described in detail below Referring to the accompanying drawings, in which:

FIG. 1 is a perspective view of a child safety seat according to the present disclosure, in which a contacting portion is extended out of a supporting leg;

FIG. 2 is a perspective view of the child safety seat according to the present disclosure, in which the contacting portion is retracted into the supporting leg;

FIG. 3 is a perspective view of the supporting leg according to the present disclosure;

FIG. 4 is a perspective view of the supporting leg according to the present disclosure, in which a cover is removed to show a structure under the cover;

FIG. 5 is an exploded perspective view of the supporting leg according to the present disclosure;

FIG. 6 is a perspective view of a traction element, a traction element sleeve and a holding sleeve of a contact indicating mechanism according to the present disclosure;

FIGS. 7 and 8 are perspective views of the supporting leg according to the present disclosure from different angles, in which the cover and a bracket are removed to show structures of other components;

FIG. 9A is a longitudinal side cross-sectional view of an upper end of the supporting leg in an ungrounded state;

FIG. 9B is a longitudinal side cross-sectional view of the upper end of the supporting leg in a grounded state;

FIG. 10A is a longitudinal front cross-sectional view of a bottom end of the supporting leg in the ungrounded state;

FIG. 10B is a longitudinal front cross-sectional view of the bottom end of the supporting leg in the grounded state;

FIG. 11 is a schematic view of the supporting leg in an extended state according to a first embodiment of the present disclosure;

FIG. 12 shows a traction element in FIG. 11;

FIG. 13 is a schematic view of the supporting leg in a retracted state according to the first embodiment of the present disclosure;

FIG. 14 shows the traction element in FIG. 13;

FIG. 15 is a schematic view of the supporting leg in the extended state according to the prior art;

FIG. 16 is a schematic view of the traction element according to a second embodiment of the present disclosure;

FIG. 17 is a schematic view of the supporting leg in the extended state according to a third embodiment of the present disclosure;

FIG. 18 is a schematic view of the supporting leg in the retracted state according to the third embodiment of the present disclosure;

FIG. 19 is a perspective view of the child safety seat of the present disclosure, in which the supporting leg is in an unfolded position and an extended position;

FIG. 20 is a partial perspective view of the child safety seat according to an embodiment of the present disclosure, in which a first cover portion for covering an end of the supporting leg is removed to show an internal structure;

FIG. 21 is a perspective view of the child safety seat of the present disclosure, in which the supporting leg is in a folded position and a retracted position;

FIG. 22 is a bottom perspective view of the child safety seat of the present disclosure, in which the supporting leg is in the folded position and the retracted position;

FIG. 23 is a side perspective view of the child safety seat of the present disclosure, in which the supporting leg is in the folded position and the retracted position;

FIG. 24A is a cross-sectional view taken along a line A-A in FIG. 22 of an embodiment of the present disclosure;

FIG. 24B is a partial enlarged view of FIG. 24A;

FIG. 25A is a cross-sectional view similar to FIG. 24A, with the supporting leg of FIG. 25A in a position of being unfolded and extended;

FIG. 25B is a partial enlarged view of FIG. 25A;

FIG. 26A is a cross-sectional view similar to FIG. 24A, with the supporting leg of FIG. 26A in a completely unfolded and extended position;

FIG. 26B is a partial enlarged view of FIG. 26A;

FIG. 27A is a perspective view of the child safety seat according to an embodiment of the present disclosure, in which the supporting leg is in the position of being unfolded and extended;

FIG. 27B is a partial enlarged view of FIG. 27A;

FIG. 28A is a perspective view of the child safety seat of the present disclosure, in which a part of components are removed to show the internal structure;

FIG. 28B is a partial enlarged view of FIG. 28A;

FIG. 29A is a cross-sectional view taken along the line A-A in FIG. 22 of another embodiment of the present disclosure;

FIG. 29B is a partial enlarged view of FIG. 29A;

FIG. 30A is a cross-sectional view similar to FIG. 29A, with the supporting leg of FIG. 30A in the position of being unfolded and extended;

FIG. 30B is a partial enlarged view of FIG. 30A;

FIG. 31A is a cross-sectional view similar to FIG. 29A, with the supporting leg of FIG. 31A in a further unfolded and extended position;

FIG. 31B is a partial enlarged view of FIG. 31A;

FIG. 32A is a cross-sectional view similar to FIG. 29A, with the supporting leg of FIG. 31A in the completely unfolded and extended position;

FIG. 32B is a partial enlarged view of FIG. 32A;

FIG. 33A is a cross-sectional view taken along a line B-B in FIG. 22 of yet another embodiment of the present disclosure;

FIG. 33B is a partial enlarged view of FIG. 33A;

FIG. 34A is a cross-sectional view similar to FIG. 33A, with the supporting leg of FIG. 34A in the position of being unfolded and extended;

FIG. 34B is a partial enlarged view of FIG. 34A;

FIG. 35A is a cross-sectional view similar to FIG. 33A, with the supporting leg of FIG. 35A in the further unfolded and extended position;

FIG. 35B is a partial enlarged view of FIG. 35A;

FIG. 36A is a cross-sectional view similar to FIG. 33A, with the supporting leg of FIG. 36A in the completely unfolded and extended position;

FIG. 36B is a partial enlarged view of FIG. 36A;

FIG. 37A is a cross-sectional view taken along the line B-B in FIG. 22 of yet another embodiment of the present disclosure;

FIG. 37B is a partial enlarged view of FIG. 37A;

FIG. 38A is a cross-sectional view similar to FIG. 37A, with the supporting leg of FIG. 38A in the position of being unfolded and extended;

FIG. 38B is a partial enlarged view of FIG. 38A;

FIG. 39A is a cross-sectional view similar to FIG. 37A, with the supporting leg of FIG. 39A in the further unfolded and extended position;

FIG. 39B is a partial enlarged view of FIG. 39A;

FIG. 40A is a cross-sectional view similar to FIG. 37A, with the supporting leg of FIG. 40A in the completely unfolded and extended position;

FIG. 40B is a partial enlarged view of FIG. 40A.

FIG. 41 is a perspective view of the child safety seat according to the present disclosure, in which the supporting leg is in an unfolded and extended state, and the supporting leg telescopic mechanism is in the extended state;

FIG. 42 is a perspective view of the child safety seat according to the present disclosure, in which the supporting leg is in a retracted and folded state, and the supporting leg telescopic mechanism is in the retracted state;

FIG. 43 is an exploded perspective view of the child safety seat;

FIG. 44 is a perspective view of the supporting leg telescopic mechanism and the supporting leg according to the present disclosure, in which the supporting leg telescopic mechanism is in the extended state;

FIG. 45 is a perspective view of the supporting leg telescopic mechanism and the supporting leg according to the present disclosure, in which the supporting leg telescopic mechanism is in a completely retracted state and the supporting leg has been folded;

FIG. 46A is a perspective view of a fixed sliding frame of the child safety seat, and FIG. 46B is a perspective view of the fixed sliding frame of the child safety seat according to another embodiment;

FIG. 47 is a perspective view of a movable sliding frame of the child safety seat;

FIG. 48 is a perspective view of a decorative cover of the child safety seat;

FIG. 49 is a perspective view of a locking element of the child safety seat;

FIG. 50 is a perspective view of an elastic element of the child safety seat;

FIGS. 51 and 52 are perspective views of a mounting seat of the child safety seat from different angles;

FIGS. 53A to 53C respectively show partial enlarged side views of the supporting leg telescopic mechanism in the extended state, a transitional state and the completely retracted state, in which the decorative cover is removed to clearly show other components;

FIGS. 54A to 54C respectively show partial enlarged side cross-sectional views of the supporting leg telescopic mechanism in the extended state, the transitional state and the completely retracted state;

FIGS. 55A to 55C respectively show partial enlarged top views of the supporting leg telescopic mechanism in the extended state, the transitional state and the completely retracted state, in which the decorative cover is removed to clearly show other components;

FIG. 56 is a partial enlarged top perspective view showing the movable sliding frame and a limiting pin;

FIG. 57 is a partial enlarged bottom perspective view showing the locking element and the elastic element;

FIGS. 58A and 58B show partial enlarged side cross-sectional views of the locking element in a locking state and an unlocking state, respectively; and

FIG. 59A, FIG. 59B and FIG. 59C respectively show partial enlarged side cross-sectional views of the supporting leg in the unfolded position, an intermediate position and the folded position.

### LIST OF REFERENCE NUMERALS

10 supporting leg
   101 first tube
      101a limiting portion
      101b adjusting device
   102 second tube
100 contact indicating mechanism
   110 indicator
      111 first area
      112 second area
      113 first accommodating portion
      114 movable shaft
   120 mounting element
   130 driving element
      131 contacting portion
      132 column hole
      133 second accommodating portion
      135 shoulder
   140 fixing seat
      141 column
   150 traction element
      151 first end of traction element
      152 second end of traction element
   155 traction element sleeve
      155a first end of traction element sleeve
      155b second end of traction element sleeve
      155c winding section
      155d adjusting section
      155e extending section
   156 holding sleeve
      156a first end of holding sleeve
      156b second end of holding sleeve
   160 decorative cover
      166 hollow portion or transparent window
   170 bracket
      171 sliding mechanism
   181 first screw
   182 first elastic element
   183 second elastic element
   184 second screw
200 carrier
   210 base
   220 seat
D1 inner diameter of second tube
D2 diameter of winding section
L1 length of holding sleeve
L2 length of adjusting section
1S carrier
   10S base
   11S first cover portion
   12S second cover portion
      121S buffer portion
      122S deformation groove
      123S deformation space
   13S fixing bracket
      131S locking hole
      132S groove
   14S movable bracket
      141S restoring element
   15S locking element
      151S locking seat
      152S locking pin
      153S driving element
   16S buffer portion
      161S protrusion
   17S, 17BS cam
      171BS protrusion
         1711BS first protruding surface
         1712BS second protruding surface
      172S, 172BS pivot shaft
      173S elastic element
   18S base housing
      181S accommodating portion
      182S locking mechanism
      183S blocking concave portion
      184S blocking protrusion
      185S locking element
   19S buffer element
      191S protrusion
         1911S first surface
         1912S second surface
   20S supporting leg
      210S first section
      220S second section
   30S seat portion
   40S linkage
1T carrier
   100T supporting leg
      101T ground contacting indicator
200T supporting leg telescopic mechanism
   210T fixed sliding frame
      211T fixed sliding groove
      212T limiting groove
      215T first locking hole
      216T third locking hole
   220T movable sliding frame
      221T movable sliding groove
      223T clamping groove
      224T notch
      225T second locking hole
   240T locking element
      241T unlocking portion
      242T locking protrusion
   250T decorative cover
      251T decorative cover sliding groove
      252T decorative cover hole
      253T window
   260T auxiliary elastic element
   270T pivot shaft
   291T sliding pin
   292T limiting pin
   293T limiting spacer
   294T elastic element
      294aT clamping protrusion
300T body
500T anti-pinch hand rotating mechanism
   510T anti-pinch cover
      511T step portion
   520T mounting seat
      521T contact bar
      522T limiting hook
DIT folding direction
D2T retracting direction

### DETAILED DESCRIPTION

Although the present disclosure has been illustrated and described Referring to specific embodiments, the present disclosure should not be limited to the details shown. Exactly, many modifications can be made to these details within the scope of the equivalents of the claims without departing from the present disclosure.

The description of directions such as “front”, “rear”, “up”, and “down” mentioned in the text is only for convenience of understanding. The present disclosure is not limited to these directions, but can be adjusted according to the actual situation.

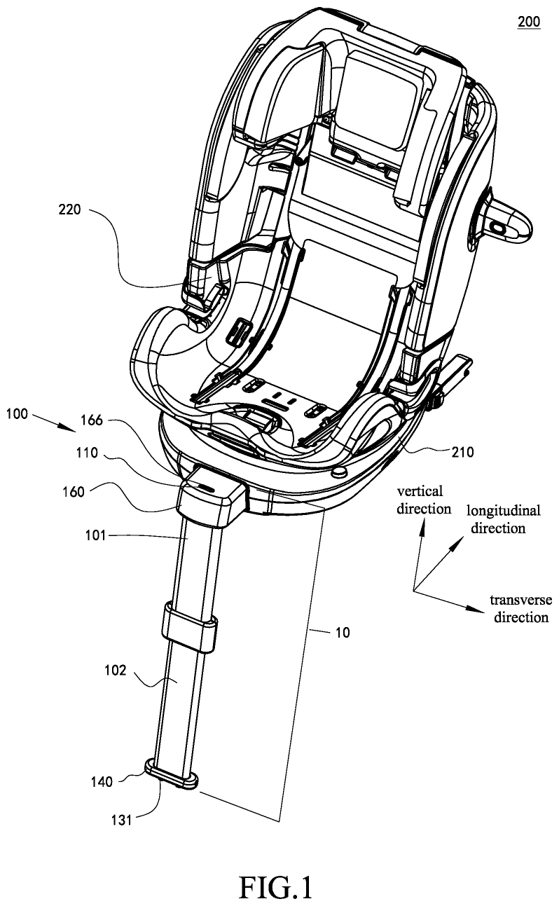

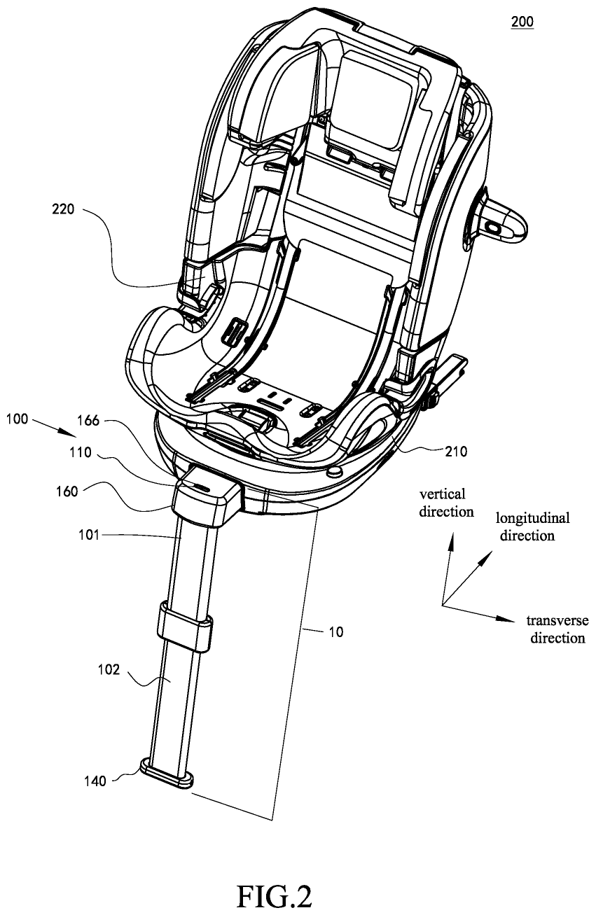

Please refer to FIGS. 1 to 2 for an overall description of a carrier 200 according to the present disclosure. In the embodiment of the present disclosure, the carrier 200 is a child safety seat, but it is not limited thereto. The present disclosure is applicable to any carrier 200 in which a supporting leg 100 is required.

As shown, the carrier 200 includes a base 210 and a seat 220. The base 210 is a part for fixing the carrier 200 to a vehicle seat, and the seat 220 is a part for carrying an occupant (i.e., a child). The supporting leg 10 is installed under the base 210, more specifically on a front side under the base 210, and configured to support the base 210 to a surface such as a floor of a vehicle, so as to prevent the child safety seat from being overturned forward when the vehicle bumps.

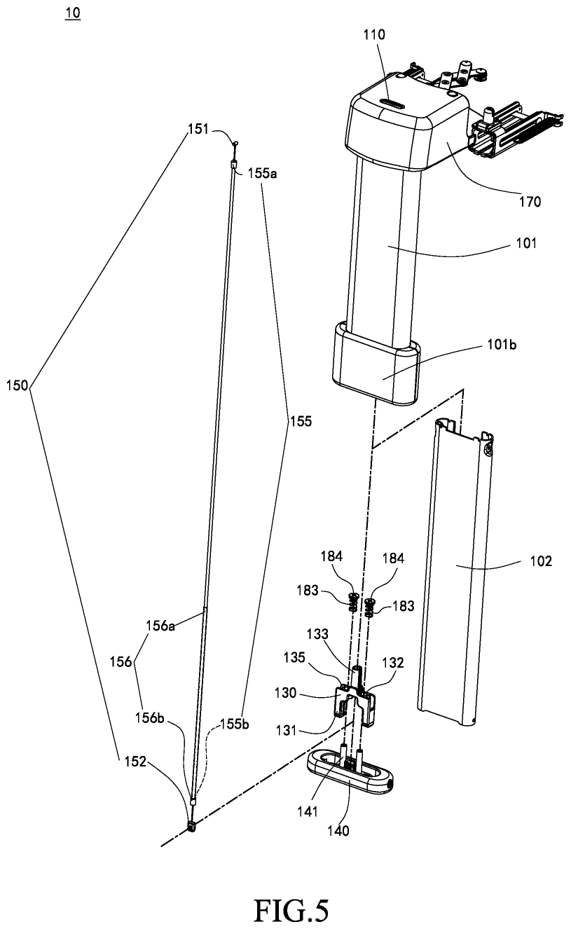

In one embodiment, the supporting leg 10 is connected to the base 210 through a retractable bracket 170 (see FIG. 5), so that it is movable in a longitudinal direction (i.e., a front-rear direction) with respect to the base 210 so as to extend out of the base 210 or retract into a position under the base 210. It should be understood that the supporting leg 10 may be directly connected to the base 210.

A decorative cover 160 may cover above the supporting leg 10, and a hollow portion or a transparent window 166 may be disposed at a front end of the decorative cover 160, so that the user can observe an indicator 110 disposed on the supporting leg 10.

A fixing seat 140 is disposed at a bottom end of the supporting leg 10, and a contacting portion 131 capable of moving in a telescopic manner is disposed in the fixing seat 140. When the supporting leg 10 is not in contact with a surface such as the ground, the contacting portion 131 extends out of the fixing seat 140, as shown in FIG. 1. When the supporting leg 10 contacts with the surface such as the ground, the contacting portion 131 is pushed by the surface and retracts into the fixing seat 140, and simultaneously causes a movement of the indicator 110 of the contact indicating mechanism 100 to provide a contacting indication, as shown in FIG. 2. The indicator 110 is used to display whether the bottom end of the supporting leg 10 contacts with the ground. The ground is, for example, a surface of a floor of a vehicle. The structure and principle of the contact indicating mechanism 100 will be described in detail below.

An upper end of the supporting leg 10 (in this embodiment, the upper end of the supporting leg 10 may be the indicating end) is connected to the bracket 170. Alternatively, in an embodiment without the bracket 170, the upper end of the supporting leg 10 is directly connected to the base 210. The bottom end of the supporting leg 10 (in this embodiment, the bottom end of the supporting leg 10 may be the contacting end) is used to contact with the ground.

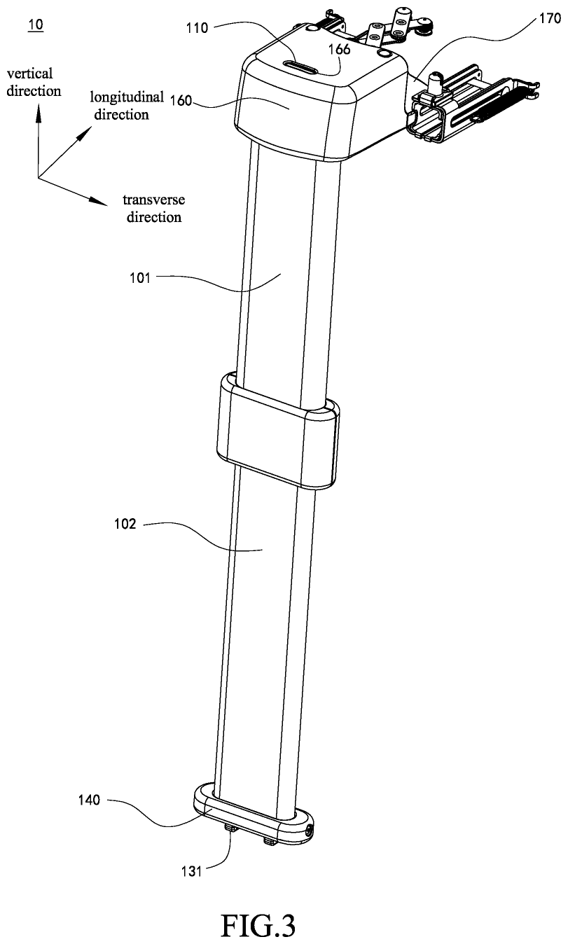

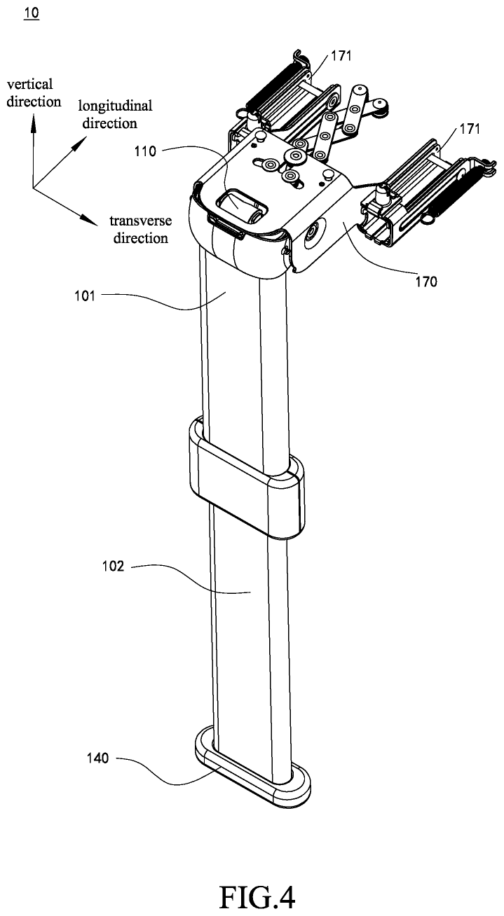

Referring to FIGS. 3 to 4, the supporting leg 10 according to the present disclosure will be further described in whole. The bracket 170 used for connecting the supporting leg 10 to the base 210 includes a sliding mechanism 171. The sliding mechanism 171 is a hinged scissor connecting rod and/or a slide rail, and the sliding mechanism 171 may be provided with a spring to bias the supporting leg 10 to a position under the base 210.

Referring to FIG. 3, it can be clearly seen that the indicator 110 of the contact indicator mechanism 100 is exposed to a user's sight through the hollow portion or transparent window 166 on the decorative cover 160, so as to be observed by the user.

Referring to FIG. 5, specific structures of the supporting leg 10 and the contact indicating mechanism 100 according to the present disclosure will be described.

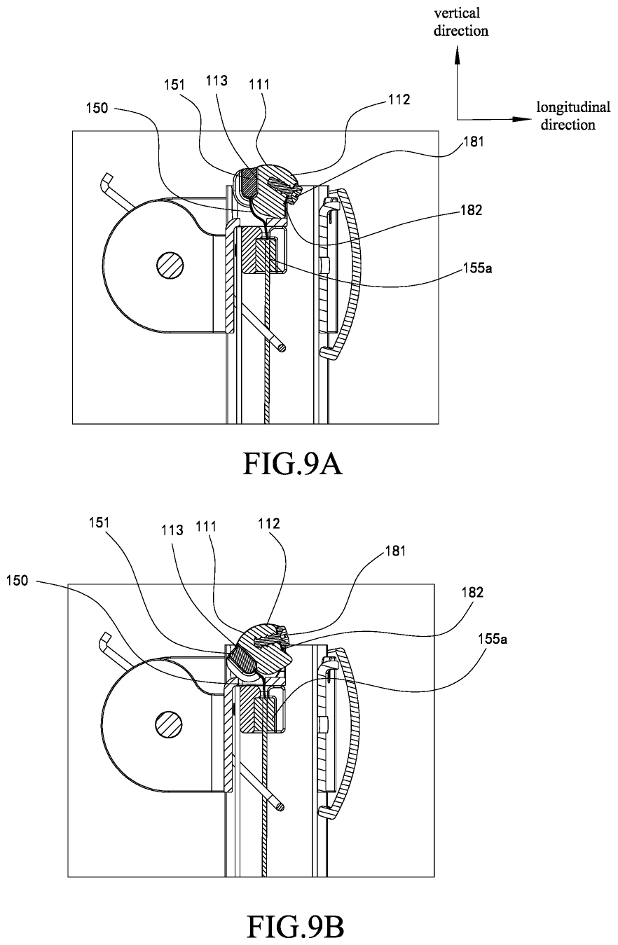

The supporting leg 10 includes a first tube 101, a second tube 102, and a contact indicating mechanism 100. The contact indicating mechanism 100 includes an indicator 110, a driving element 130, a traction element 150, a traction element sleeve 155, a holding sleeve 156, a fixing seat 140, a first elastic element 182, a first screw 181 (FIGS. 9A and 9B), a second elastic element 183 and a second screw 184.

The first tube 101 has an indicating end, and the second tube 102 has a contacting end. The first tube 101 is connected to the second tube 102 through an adjusting device 101b (e.g., a clamping element or a pin, but the present disclosure is not limited thereto.) to allow an overall length of the supporting leg 10 to be adjusted. In one embodiment, the first tube 101 is sleeved on the outside the second tube 102.

The driving element 130 is at least partially disposed in the contacting end of the supporting leg 10, that is, disposed at the bottom end of the second tube 102. The driving element 130 includes a contacting portion 131 extending in a vertical direction towards an external of the contacting end. The driving element 130 can move relative to the contacting end between an extended position (see FIG. 1) where the contacting portion 131 extends out of the contacting end and a retracted position (see FIG. 2) where the contacting portion 131 retracts into the contacting end.

More specifically, the driving element 130 may include a shoulder 135 and a column hole 132. The shoulder 135 is located in the contacting end of the supporting leg 10 and extends approximately transversely, and two contacting portions 131 respectively extend out of the contacting end vertically outward from two transverse ends of the shoulder 135 respectively. The column hole 132 is formed on the shoulder 135, and the column hole 132 can be slidably sleeved on the column 141 extending inward from the bottom of the contacting end.

In one embodiment, a second elastic element 183 is disposed between the driving element 130 and the contacting end, and the second elastic element 183 biases the driving element 130 to the extended position. The second elastic element 183 may be a coil spring. The second elastic element 183 is sleeved on the column 141. An end of the second elastic element 183 abuts against an inner side of the second screw 184, and the other end of the second elastic element abuts against the shoulder 135 to bias the driving element 130 to the extended position. It should be understood that the arrangement of the second elastic element 183 is not limited thereto, as long as the driving element 130 is biased by the second elastic element 183 to the extended position.

The driving element 130 further includes a holding sleeve mounting portion (i.e., a second accommodating portion 133) extending vertically inward from a center of the shoulder 135 in a form of a groove and having a shape corresponding to a second end 156b of the holding sleeve to fix the second end 156b of the holding sleeve. It should be understood that the form of the second accommodating portion 133 is not limited thereto, and may be changed according to the form of the second end 156b of the holding sleeve.

The fixing seat 140 is a substantially flat component extending in a transverse direction and a longitudinal direction. In the embodiment in which the fixing seat 140 is provided as a separate component, the bottom end (i.e., the contacting end) of the supporting leg 10 may be an open end, and the fixing seat 140 is used to close the open end. The column 141 is disposed on an inner side of the fixing seat 140. The fixing seat 140 is provided with a through hole, so that the contacting portion 131 of the driving element 130 extends to the outside of the supporting leg 10 through the fixing seat 140. As shown above, the fixing seat 140 can be integrated into the second tube 102 as an integral component.

The traction element 150 extends approximately vertically between the indicating end and the contacting end of the supporting leg 10, and may be wound with extending and retracting of the supporting leg 10, which will be described in detail below.

The traction element sleeve 155 is sleeved on an outside of an upper part of the traction element 150 (i.e., a part of the outside of the traction element 150 close to the indicating end) and an outside of a lower part of the traction element 150 (i.e., a part of the outside of the traction element 150 close to the contacting end). In this embodiment, the traction element sleeve 115 is continuously sleeved on the outside of the upper part and the lower part of the traction element 150 as a whole. It should be understood that in other embodiments, the traction element sleeve 115 may also be divided into a plurality of sections, that is, it includes a section sleeved on the outside of the upper part of the traction element 150 and a section sleeved on the outside of the lower part of the traction element 150. The traction element sleeve 155 includes a first end 155a of the traction element sleeve connected to the indicating end and a second end 155b of the traction element sleeve connected to the driving element 130. The traction element sleeve 155 may be made of a material such as rubber or plastic, which has certain flexibility and can be bent and wound, but its length will not change substantially. Alternatively, in other embodiments, the traction element 155 may be connected to the holding sleeve 156 in sequence, that is, the second end 155b of the traction element sleeve is connected to a first end 156a (not shown) of the holding sleeve instead of the driving element 130.

The holding sleeve 156 is sleeved on the outside of the lower part of the traction element 150, that is, the part of the outside of the traction element 150 close to the contacting end. The holding sleeve 156 includes a first end 156a of the holding sleeve located near a middle of the traction element 150 and a second end 156b of the holding sleeve connected to the driving element 130. The holding sleeve 156 may be made of a hard leather or metal material, which is substantially inflexible and does not change in length.

The holding sleeve 156 is sleeved on the part of the outside of the traction element sleeve 155 close to the contacting end, and the second end 156b of the holding sleeve may be sleeved on an outside of the second end 156b of the traction element sleeve. Alternatively, the traction element sleeve 155 and the holding sleeve 156 are of an integral structure, which will be described in detail in a second embodiment below.

In one embodiment, both the first end 155a of the traction element sleeve and the second end 156b of the holding sleeve are in the form of a hammerhead with an increased diameter at both ends so as to be connected to the indicating end and the driving element 130. It should be understood that the first end 155a of the traction element sleeve and the second end 156b of the holding sleeve may also take other forms, such as an external thread, an elastic clamping element, or be directly welded to the indicating end and the driving element 130.

The traction element 150 includes a first end 151 of the traction element extending out of the first end 155a of the traction element sleeve and a second end 152 of the traction element extending out of the second end 156b of the holding sleeve. The first end 151 of the traction element is connected to the indicator 110, and can drive the indicator 110 to rotate around a movable shaft 114 (see FIGS. 9A and 9B). The second end 152 of the traction element is connected to the contacting end, and more specifically, the second end 152 of the traction element is connected to the fixing seat 140. The traction element 150 is made of, for example, a steel wire, nylon wire or carbon fiber, which has certain flexibility and can be bent, but its length will not change substantially.

In one embodiment, both the first end 151 of the traction element and the second end 152 of the traction element are in the form of the hammerhead with an increased diameter at both ends. It should be understood that the first end 151 of the traction element and the second end 152 of the traction element may also take other forms, such as an external thread, knotting, or be directly welded to the indicating end and the contacting end.

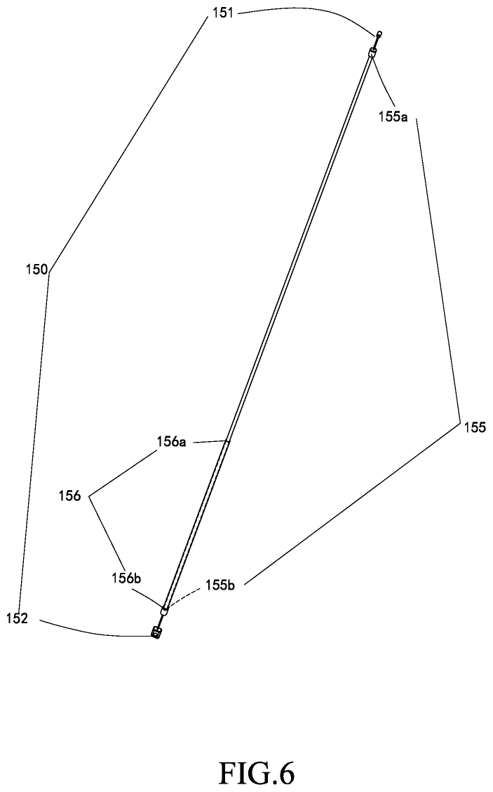

Referring to FIG. 6, specific structures of the traction element 150, the traction element sleeve 155 and the holding sleeve 156 can be seen more clearly.

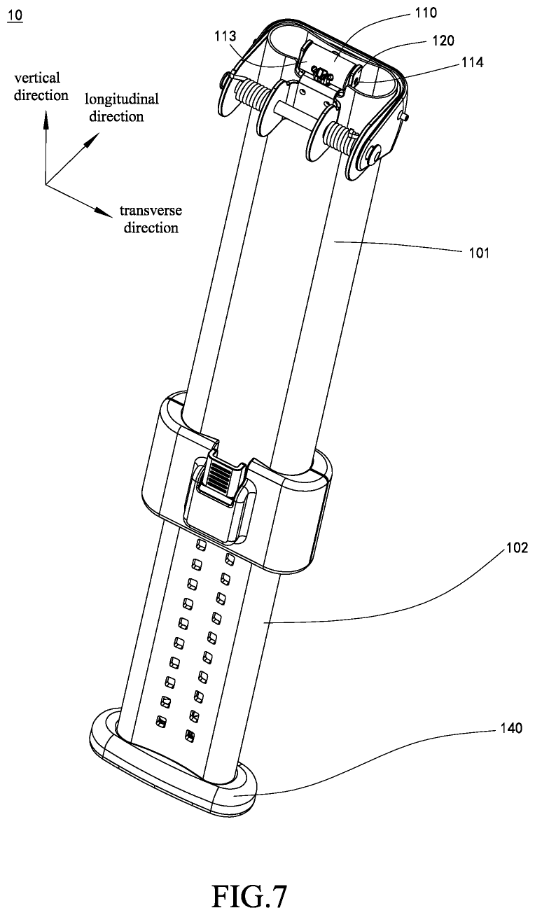

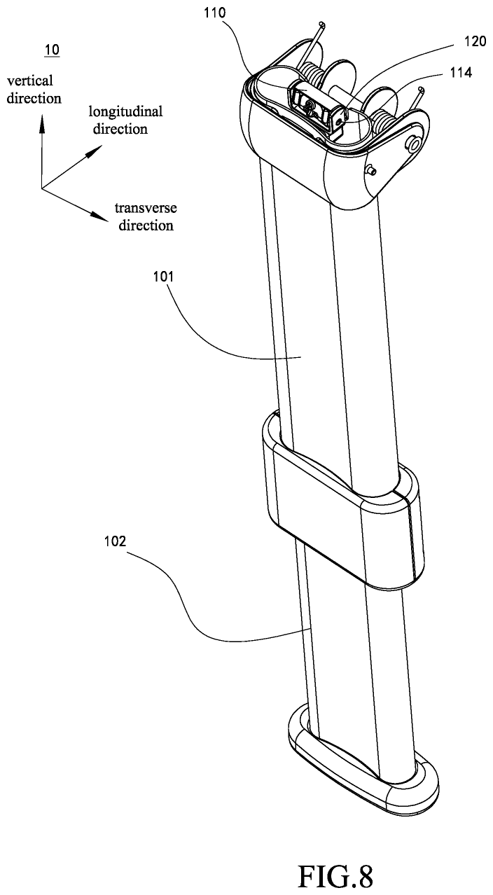

Referring to FIGS. 7 to 8, a mounting element 120 and the indicator 110 of the contact indicating mechanism 100 according to the present disclosure will be described in detail.

The mounting element 120 is disposed at a top end of the supporting leg 10. The mounting element 120 is, for example, two sheet-like parts arranged in the transverse direction, and the movable shaft 114 is disposed on the mounting element 120 in the transverse direction. The indicator 110 is disposed at the indicating end of the supporting leg 10 through the movable shaft 114, and can rotate around the movable shaft 114 between a first position and a second position (the first position and the second position will be described in detail below).

Referring to FIGS. 9A to 9B, a specific structure of the indicating end of the supporting leg 10 of the present disclosure will be described.

A first area 111 and a second area 112 are circumferentially disposed on a cylindrical periphery of the indicator 110. When the supporting leg 10 is in an ungrounded position, the indicator 110 is in the first position, and the first area 111 is exposed from the hollow portion or the transparent window 166. When the supporting leg 10 is in a grounded position, the indicator 110 is in the second position, and the second area 112 is exposed from the hollow portion or the transparent window 166. For example, the first area 111 may be red and the second area 112 may be green, or the first area 111 and the second area 112 may be painted with different marks (such as dots, diagonal lines or other patterns), so long as they can be used to indicate whether the supporting leg 10 contacts with the ground, the embodiments of the present disclosure do not limit the expression of the first area 111 and the second area 112. The shapes of the first area 111 and the second area 112 may correspond to the shapes of the hollow portion or the transparent window 166.

A first side of the indicator 110 has a first accommodating portion 113 for connecting the traction element 150. The first end 151 of the traction element is connected to the first accommodating portion 113. A second side of the indicator 110 is connected to an end of the first elastic element 182. For example, an end of the first elastic element 182 is connected to the second side of the indicator 110 by a first screw 181. The other end of the first elastic element 182 abuts against the indicating end. In one embodiment, the first side of the indicator 110 is opposite to the second side of the indicator 110.

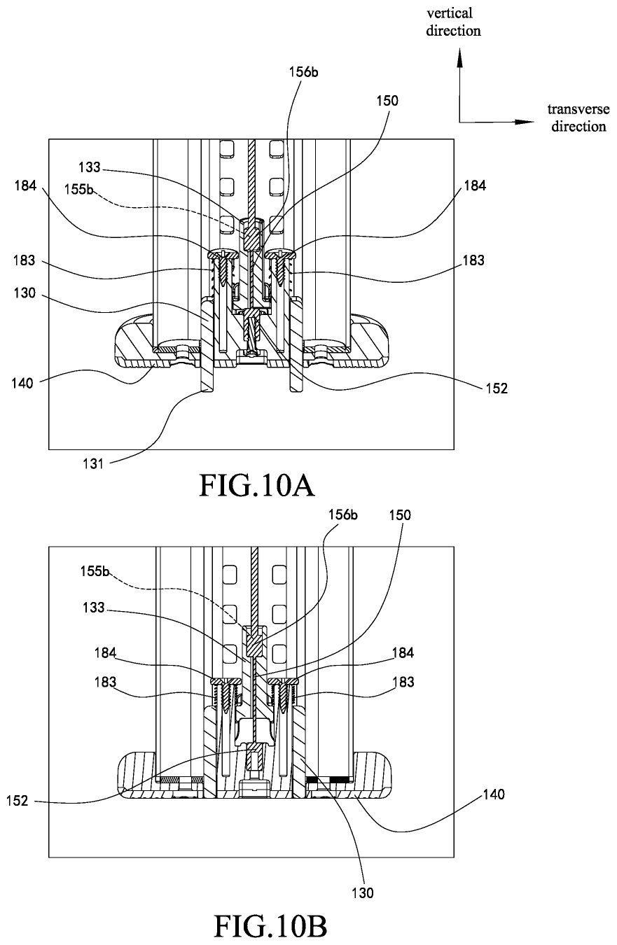

In the situation shown in FIGS. 9A and 10A, the indicator 110 is in the first position and the driving element 130 is in the extended position. The first area 111 of the indicator 110 faces upward (i.e., a position where the hollow portion or the transparent window 166 on the decorative cover 160 is located) to show that the supporting leg 10 is not in contact with the ground. Due to a biasing action of the first elastic element 182 and the second elastic element 183, the indicator 110 and the driving element 130 tend to remain in the positions shown in FIGS. 9A and 10A without an influence of an external force.

In other embodiments, the indicator 110 may be configured to move linearly instead of rotating. For example, the indicator 110 is disposed in the indicating end through a slide rail and can slide between the second position and the first position. Without an external force, the indicator 110 is biased to the first position. When the contacting end contacts the surface, the traction element 150 (specifically, the first end 151 of the traction element) will drive the indicator 110 to move to the second position against a biasing force. The slide rail may be transversely disposed, and a vertical movement of the traction element 150 is converted into a transverse movement by a pulley at the indicating end. The slide rail may also be vertically disposed, and the hollow portion or transparent window 166 is formed on a vertical surface of the decorative cover 160.

Referring to FIGS. 10A to 10B, a specific structure of the contacting end of the supporting leg 10 of the present disclosure will be described.

The driving element 130 can move vertically relative to the fixing seat 140. The second end 152 of the traction element of the traction element 150 is connected to the contacting end (specifically connected to the fixing seat 140), and the second end 156b of the holding sleeve of the holding sleeve 156 is connected to the driving element 130 (specifically connected to the second accommodating portion 133). Therefore, the second end 156b of the holding sleeve moves with the driving element 130, while the second end 152 of the traction element does not move with the driving element 130.

When the contacting end is not in contact with the ground, the driving element 130 is biased by the second elastic element 183, so that the contacting portion 131 of the driving element extends out of the supporting leg 10 through the fixing seat 140 (see FIG. 10A). When the contacting end contacts with the ground, the contacting portion 131 of the driving element 130 is first pressed by the ground, and thus moves to the retracted position against the bias of the second elastic element 183 (see FIG. 10B). Therefore, the driving element 130 drives the second end 156b of the holding sleeve to move away from the contacting end (i.e., move upward). Meanwhile, since the second end 152 of the traction element is connected to the contacting end, the second end 152 of the traction element does not move away from the contacting end, that is, does not move upward. In this way, the second end 152 of the traction element extends out of the second end 156b of the holding sleeve by a certain length.

Referring to FIGS. 9A to 10B, an operation of the supporting leg 10 according to the present disclosure will be described.

In the state shown in FIGS. 9A and 10A, the contacting end is not in contact with the ground. The contacting portion 131 of the driving element 130 extends out of the fixing seat 140. The indicator 110 is not pulled by the traction element 150, so the indicator 110 is in the first position.

In the state shown in FIGS. 9B and 10B, the contacting portion 131 of the driving element 130 has contacted with the ground. The holding sleeve 156 moves upward with the driving element 130, so that the second end 152 of the traction element extends out of the second end 156b of the holding sleeve. As described above, lengths of the traction element 150, the traction element sleeve 155 and the holding sleeve 156 are substantially unchanged, that is to say, lengths of parts of the traction element 150 in the traction element sleeve 155 and the holding sleeve 156 are substantially unchanged. In this way, when the second end 152 of the traction element extends out of the second end 156b of the holding sleeve for a certain length, the first end 151 of the traction element retracts into the first end 155a of the traction element sleeve by a corresponding length. Because the first end 155a of the traction element sleeve is fixed at the indicating end of the supporting leg 10, the traction element 150 slides towards the contacting end relative to the traction element sleeve 155, that is, moves downwards, to drive the indicator 110 to rotate from the first position to the second position. Therefore, the traction element 150 can transmit a movement of the driving element 130 to the indicator 110.

It should be understood that working principles of the traction element 150, the traction element sleeve 155 and the holding sleeve 156 are mainly related to their respective lengths, regardless of their respective bending or winding degrees. Even if the length of the supporting leg 10 changes, and the traction element 150 and the traction element sleeve 155 are correspondingly bent or wound, the traction element 150 can still transmit the movement of the driving element 130 to the indicator 110 because the lengths of the traction element 150, the traction element sleeve 155 and the holding sleeve 156 are substantially unchanged.

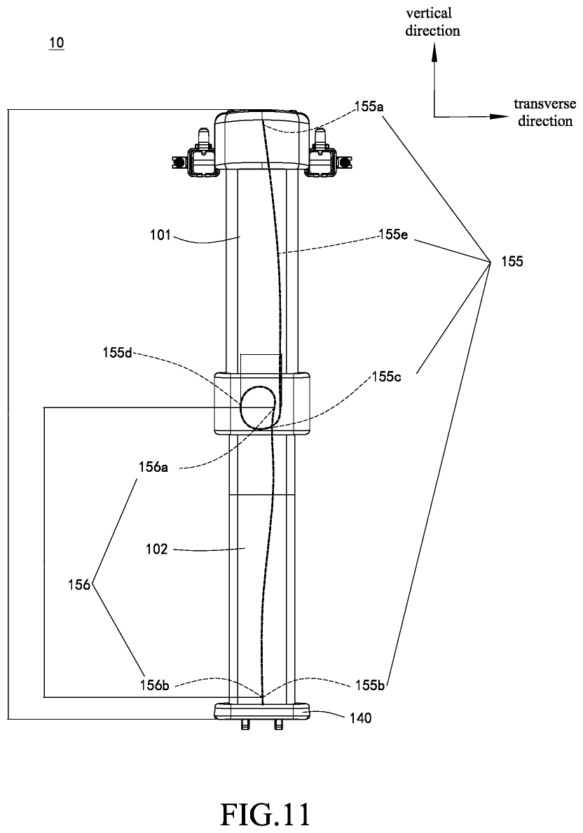

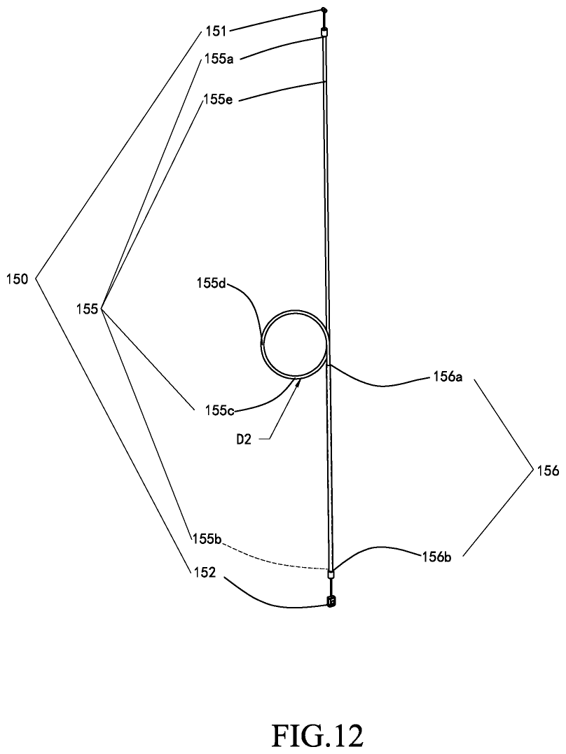

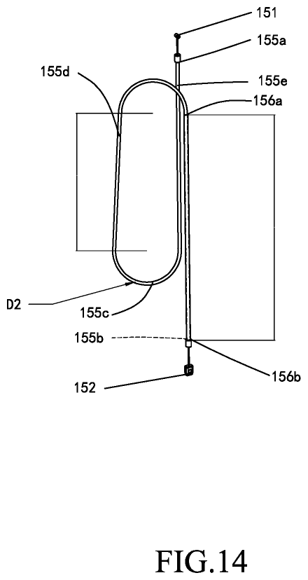

Referring to FIGS. 11 to 14, operations of the traction element sleeve 155 and the holding sleeve 156 according to a first embodiment of the present disclosure will be described. It should be understood that, for convenience of understanding, the traction element 150, the traction element sleeve 155 and the holding sleeve 156 are not shown in a curled state or a wound state in FIGS. 5 and 6. However, the traction element 150, the traction element sleeve 155 and the holding sleeve 156 may be in the curled state or in the wound state in the embodiment shown in FIGS. 5 and 6.

As described above, the traction element sleeve 155 is made of a flexible material that can be bent or wound. In order to adapt to a change of the length of the supporting leg 10, the traction element sleeve 155 is wound in a ring shape inside the supporting leg 10. For convenience of description, a part of the traction element sleeve 155 extending downward from the first end 155a of the traction element sleeve is referred to as an extending section 155e. A ring part wound from a lower end of the extending section 155e to extending upward is called a winding section 155c. The winding section 155c shown in the figure is wound by half a turn, but it may be wound by, for example, 1.5 turns, 2.5 turns, etc. A part extending upward from the winding section 155c to the second end 155b of the traction element sleeve is called a adjusting section 155d (in which a joint section between the second end 155b of the traction element sleeve and the adjusting section 155d is wound from the upper end of the adjusting section 155d for approximately half a turn and then extends downward to the second end 155b of the traction element sleeve). It should be understood that the extending section 155e, the winding section 155c and the adjusting section 155d are just names for different parts of the traction element sleeve 155. As the length of the supporting leg 10 is changed, the respective lengths of the extending section 155e, the winding section 155c and the adjusting section 155d will also change accordingly. In particular, a length of the extending section 155e and a length of the adjusting section 155d will change, so that a longitudinal dimension of the traction element sleeve 155 in the supporting leg 10 will change. Specifically, when the length of the supporting leg 10 is reduced, the length of the extending section 155e is reduced, and the length of the adjusting section 155d is increased. When the length of the supporting leg 10 is increased, the length of the extending section 155e is increased, and the length of the adjusting section 155d is reduced.

As described above, the holding sleeve 156 is substantially free of being bent or wound. Therefore, when the length of the supporting leg 10 is changed, the holding sleeve 156 substantially keeps extending vertically, while the traction element sleeve 155 is wound to different degrees to adapt to the length change of the supporting leg 10. In this way, the winding section 155c or the winding section 155c and the adjusting section 155d can be prevented from contacting the contacting end, for example, the winding section 155c is prevented from contacting the fixing seat 140. More specifically, in this embodiment, the holding sleeve 156 is sleeved on an outside of at least part extending downward of the joint section between the second end 155b of the traction element sleeve and the adjusting section 155d.

More specifically, a diameter D2 of the winding section 155c may be smaller than an inner diameter of the supporting leg 10 near the contacting end, for example, smaller than an inner diameter D1 of the second tube 102. In this way, the winding section 155c is substantially not in contact with an inner wall of the second tube 102, thus reducing resistance between them.

A sum of the diameter D2 of the winding section 155c and a length L2 of the adjusting section 155d (i.e., a maximum length of the adjusting section 155d when the supporting leg 10 is completely retracted) may be smaller than a length LI of the holding sleeve 156. In this way, even when the supporting leg 10 is completely retracted, the adjusting section 155d hanging from a top end of the holding sleeve 156 and the winding section 155c hanging from a bottom end of the adjusting section 155d would not contact the fixing seat 140.

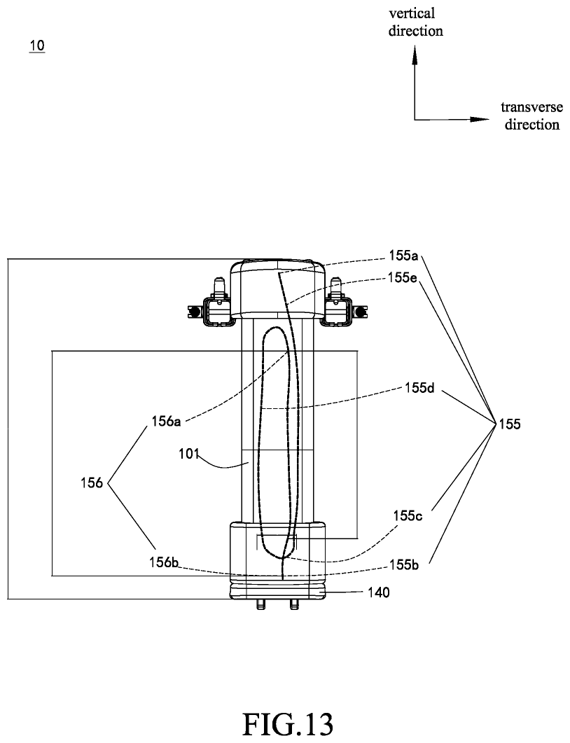

In another embodiment, a sum of the diameter D2 of the winding section 155c and a maximum adjustable length range of the supporting leg 10 may be smaller than the length L1 of the holding sleeve 156. The maximum adjustable length range of the supporting leg 10 may be a difference between a total length L of the supporting leg 10 in the extended state shown in FIG. 11 and a total length L′ of the supporting leg 10 in the retracted state shown in FIG. 13. In this way, even when the supporting leg 10 is completely retracted, the adjusting section 155d hanging from the top end of the holding sleeve 156 and the winding section 155c hanging from the bottom end of the adjusting section 155d would not contact with the fixing seat 140.

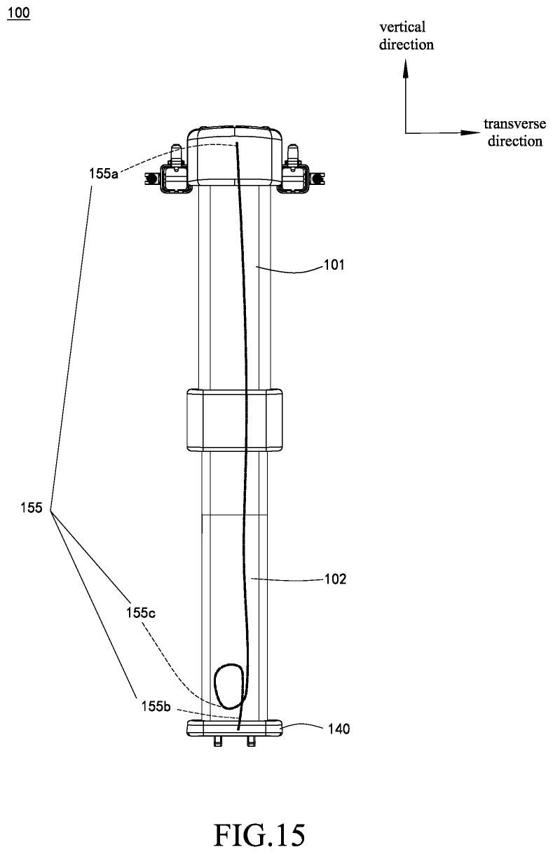

Referring to FIG. 15, a case where the holding sleeve 156 is not provided in the prior art will be described.

Without the holding sleeve 156, both ends of the traction element sleeve 155 are respectively connected to the indicating end and the contacting end of the supporting leg 10. Since all parts of the traction element sleeve 155 can be wound, the winding section 155c of the traction element sleeve 155 may move to the vicinity of the contacting end under an action of gravity or an external force, as shown in FIG. 13. In this way, the winding section 155c may directly contact the fixing seat 140. When the supporting leg 10 is retracted, the fixing seat 140 directly abuts against the winding section 155c, so that the winding section 155c cannot be normally wound, or even the winding section 155c directly abuts against the indicator 110 (not shown) of the indicating end, resulting in an abnormal operation of the indicator 110.

In contrast, the present disclosure overcomes the above problems by providing the holding sleeve 156.

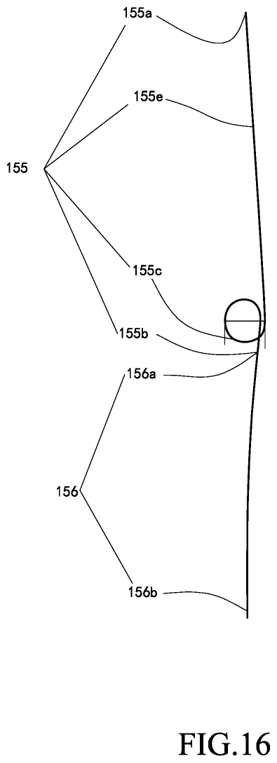

Referring to FIG. 16, the traction element sleeve 155 and the holding sleeve 156 according to a second embodiment of the present disclosure are described.

In the second embodiment, the traction element sleeve 155 and the holding sleeve 156 are integrally disposed, and the flexibility of the traction element sleeve 155 is greater than that of the holding sleeve 156. That is to say, the traction element sleeve 155 and the holding sleeve 156 are of an integrated structure, that is, the traction element sleeve 155 and the holding sleeve 156 are sleeved on the outside of the traction element 150 end to end. In this case, the traction element sleeve 155 and the holding sleeve 156 are two parts of one component with different hardness.

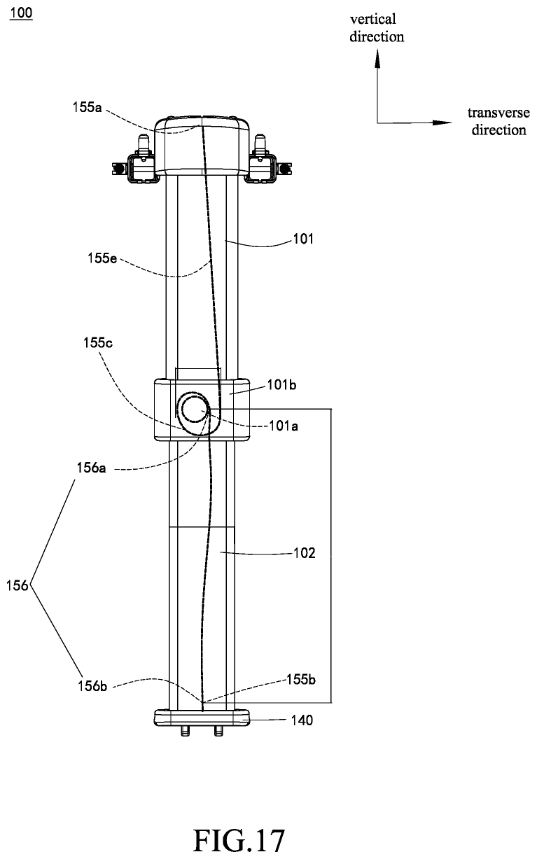

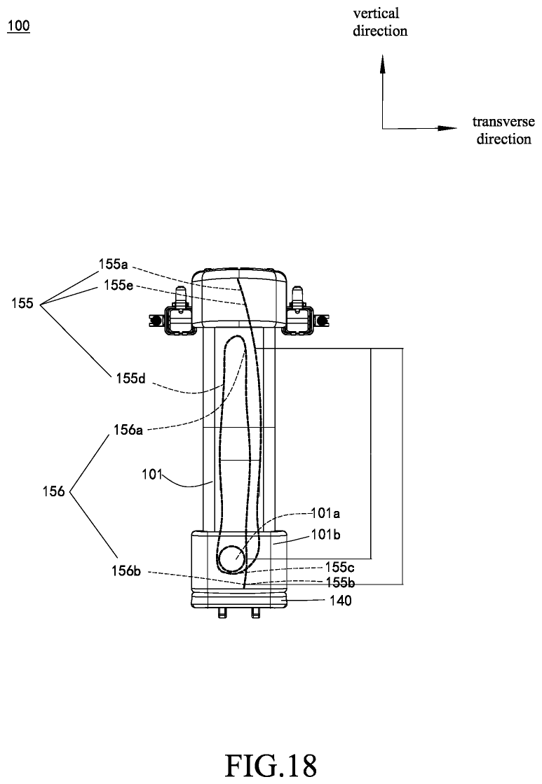

Referring to FIGS. 17 and 18, the supporting leg 10 according to a third embodiment of the present disclosure is described.

In the third embodiment, the supporting leg 10 is provided with a limiting portion 101a. The limiting portion 101a is, for example, a post or a groove disposed in the limiting device 101b.

The winding section 155c bypasses the limiting portion 101a. The limiting portion 101a is disposed to keep a distance between the winding section 155c and the indicating end substantially unchanged when the supporting leg 10 changes its length. More specifically, since the winding section 155c is wound on the limiting portion 101a, when the first tube 101 moves relative to the second tube 102, the winding section 155c will move with the first tube 101 relative to the second tube 102. In this way, the winding section 155c is prevented from falling to a position near the contacting end. In another embodiment, the winding section 155c is only wound for half a turn, and the winding section 155c and a half-turn ring connecting between the second end 155b of the traction element sleeve and the adjusting section 155d bypass the limiting portion 101a together.

To sum up, the present disclosure provides a contact indicating mechanism, which can intuitively display whether an end of a supporting leg contacts with the ground or not on the other end of the supporting leg. Moreover, the contact indicating mechanism of the present disclosure allows the length of the supporting leg to be changed, and can also realize the contact indication function thereof. The contact indicating mechanism according to the present disclosure can assist the correct positioning of the winding section of the traction element sleeve and prevent the winding section from directly contacting with the contacting end.

It should be understood that although the supporting leg is shown in the embodiment, the supporting leg of the present disclosure can be applied to various components in various shapes.

The present disclosure provides a carrier. The carrier may be a child safety seat. The carrier may be installed on a seat of a vehicle (including various transports with a seat) for infants or children to ride and ensure the safety of the infants or children. The carrier has a supporting leg which can pivot between an unfolded position and a folded position relative to the carrier and can slide between an extended position and a retracted position in a front-rear direction relative to the carrier.

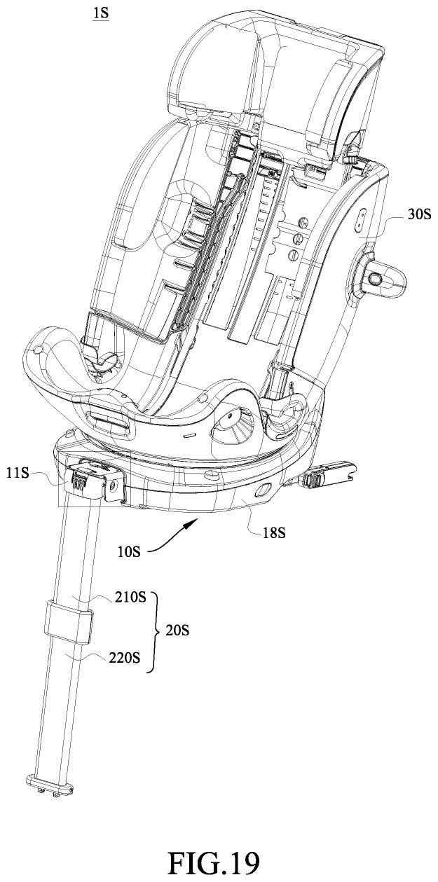

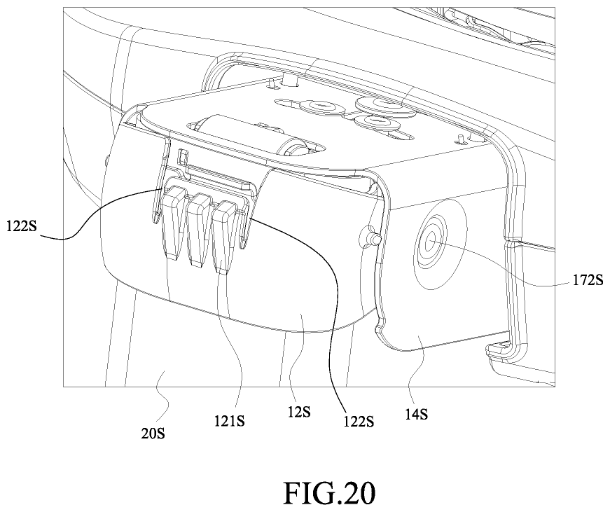

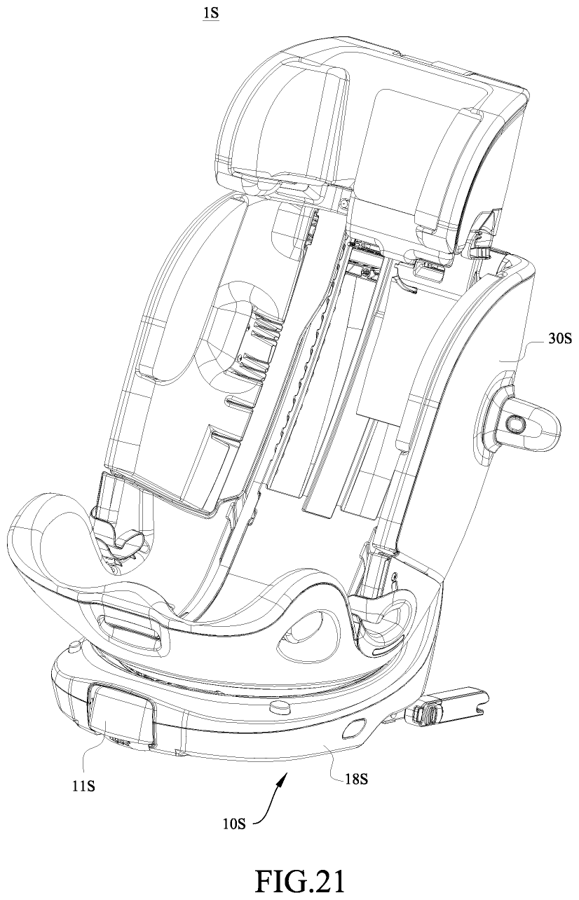

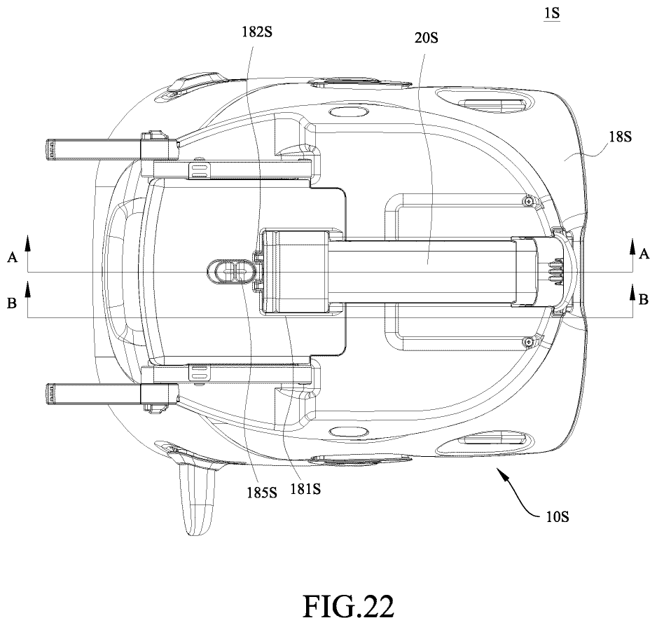

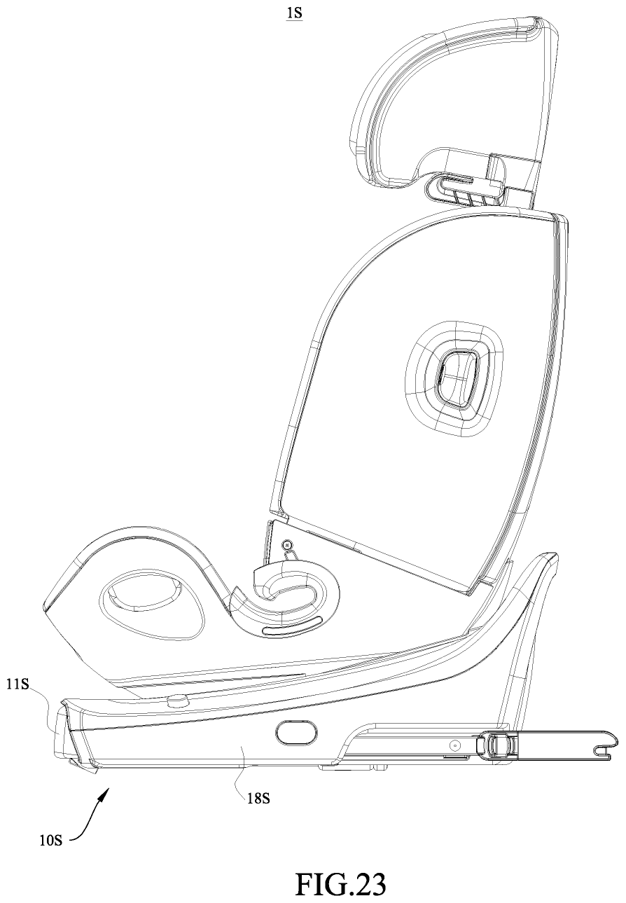

FIG. 19 is a perspective view of the carrier of the present disclosure, in which the supporting leg is in the unfolded position and the extended position. FIG. 20 is a partial perspective view of the carrier of an embodiment of the present disclosure, in which a first cover portion for covering an end of the supporting leg is removed to show an internal structure. FIG. 21 is a perspective view of the carrier of the present disclosure, in which the supporting leg is in the folded position and the retracted position. FIG. 22 is a bottom perspective view of the carrier of the present disclosure, in which the supporting leg is in the folded position and the retracted position. FIG. 23 is a side perspective view of the carrier of the present disclosure, in which the supporting leg is in the folded position and the retracted position.

Referring to FIGS. 19, 21 and 23, the carrier 1S may include a base 10S, a supporting leg 20S and a seat portion 30S. The seat portion 30S may be disposed above the base 10S. The seat portion 30S is rotatable relative to the base 10S, so that the seat portion 30S has positions facing different directions. Alternatively, the seat portion 30S may be fixed relative to the base 10S. The seat portion 30S and the base 10S may be integrated, or formed separately from each other and connected together. When the carrier 1S is installed on the seat of the vehicle, the supporting leg 20S may be disposed at the front of the base 10S (i.e., the left part in FIG. 23) and extend downward to contact with the ground (i.e., the ground in the vehicle compartment). The base 10S may have a base housing 18S. The base housing 18S may have an internal space to accommodate a plurality of components. The front of the base housing 18S may be formed with an opening. The base 10S may include a first cover portion 11S. The first cover portion 11S may be disposed at the opening to cover the opening to avoid exposing the inside of the base housing 18S. The first cover portion 11S is configured to be telescopic relative to the base 10S. Specifically, the first cover portion 11S can be extended and retracted by a certain distance in the front-rear direction (which will be described in detail below). The supporting leg 20S may include a first section 210S and a second section 220S that are telescopic. That is, since the supporting leg 20S includes the first section 210S and the second section 220S, the supporting leg 20S can be extended and retracted.

Referring to FIGS. 19 and 23, the supporting leg 20S can pivot between the folded position (FIG. 23) and the unfolded position (FIG. 19).

Referring to FIG. 22, an accommodating portion 181S may be formed at the bottom of the base housing 18S. The accommodating portion 181S may be a groove. A shape of the accommodating portion 181S may correspond to a shape of the shortened supporting leg 20S, so that the shortened supporting leg 20S can be accommodated therein. A locking button 185S may be provided on the base housing 18S. The locking button 185S may be actuated to drive the locking mechanism 182S to partially lock the supporting leg 20S in the accommodating portion 181S. The locking button 185S may be held in a locking state and an unlocking state, respectively. When the carrier IS is packaged for sale, the locking button 185S is in the unlocking state, that is, the supporting leg 20S is not locked. After the user opens the package of the carrier IS, the supporting leg 20S will be unfolded automatically, thus reminding the user not to forget to use the supporting leg 20S. This prevents the user from forgetting to set the supporting leg 20S, prevents the user from misusing the carrier 1S, and ensures the safety and correctness of using the carrier 1S.

Referring to FIG. 20, the base 10S may include a second cover portion 12S. The second cover portion 12S is pivotally disposed on the base 10S, and the supporting leg 20S is pivotally disposed on the base 10S (which will be described in detail below). The second cover portion 12S and the supporting leg 20S are linked with each other to pivot synchronously. In other words, the supporting leg 20S and the second cover portion 12S may pivot together with respect to the first cover portion 11S. The second cover portion 12S may cover a gap between the supporting leg 20S and the first cover portion 11S, thereby preventing the inside of the base housing 18S from being exposed when the supporting leg 20S pivots. The second cover portion 12S may include a buffer portion 121S. The buffer portion 121S may abut against the first cover portion 11S during pivoting of the second cover portion 12S. The buffer portion 121S may be made of an elastic material. The buffer portion 121S may be an elastic convex rib. The elastic material may be rubber or resin, and the present disclosure is not limited thereto. The buffer portion 121S may protrude from a front surface of the second cover portion 12S. The second cover portion 12S may have a plurality of buffer portions 121S. Although three buffer portions 121S are shown in FIG. 20S, the present disclosure is not limited thereto. Alternatively, the second cover portion 12S may have one, two or four buffer portions 121S.

The buffer portion 121S may be formed on the supporting leg 20S. During a movement of the supporting leg 20S from the folded position to the unfolded position, the buffer portion 121S abuts against the base 10S, so that the buffer portion 121S is elastically deformed to prevent the supporting leg 20S from pivoting. Alternatively, the buffer portion 121S may be formed on the base 10S, and during the movement of the supporting leg 20S from the folded position to the unfolded position, the buffer portion 121S abuts against the supporting leg 20S, so that the buffer portion 121S is elastically deformed to prevent the supporting leg 20S from pivoting.

The second cover portion 12S may be formed with deformation grooves 122S on both sides of the buffer portion 121S. The deformation groove 122S may make the second cover portion 12S deformed more easily when the buffer portion 121S abuts against the base 10S or the supporting leg 20S.

Alternatively, at least one of the buffer portion 121S, the first cover portion 11S, and the second cover portion 12S may be formed of an elastic material.

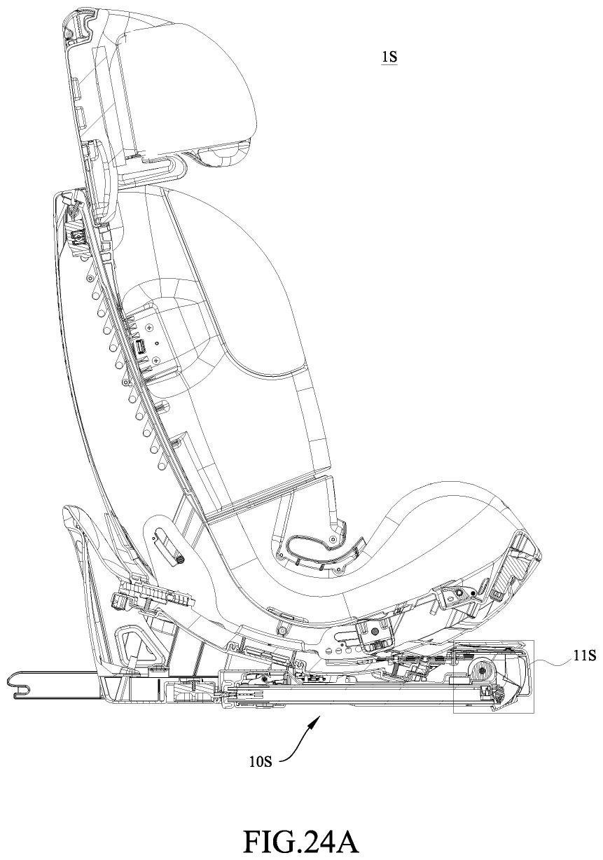

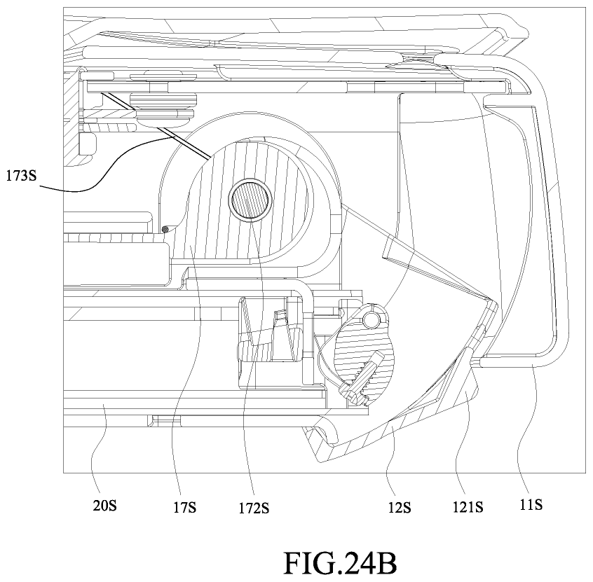

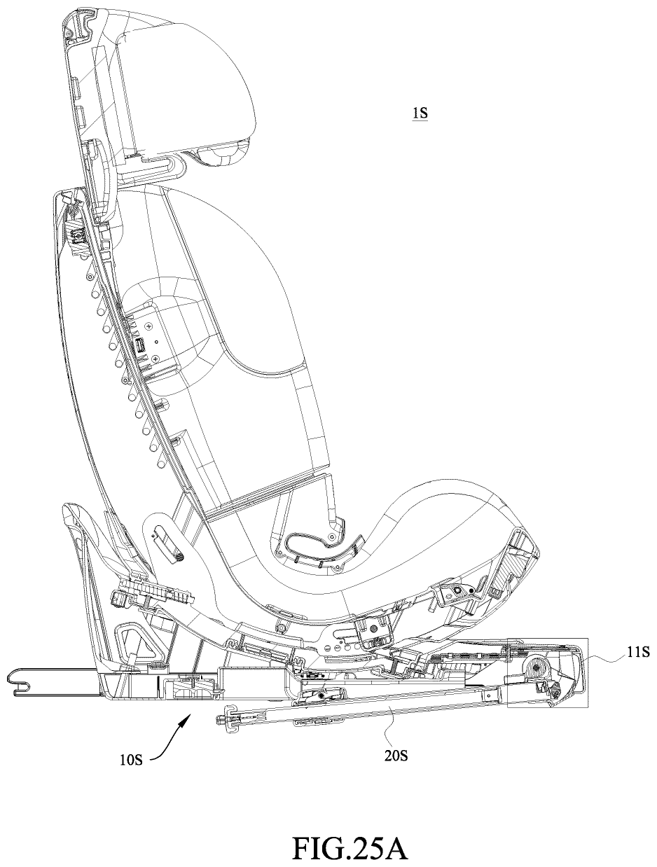

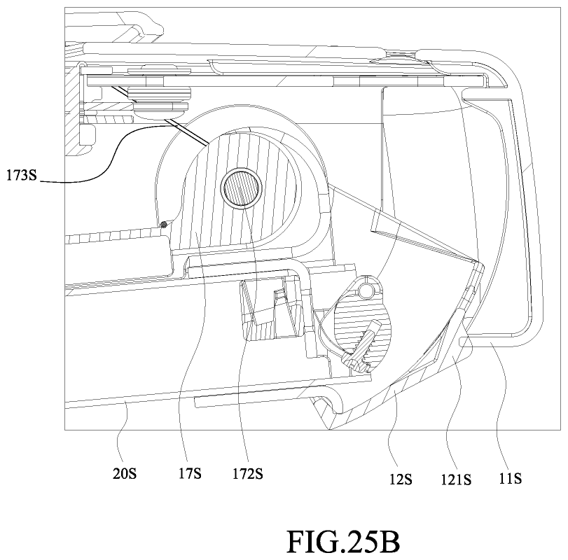

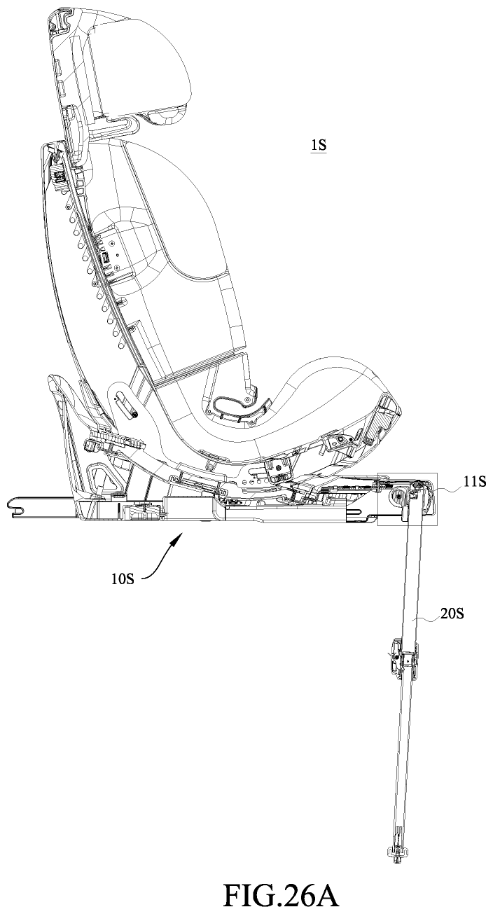

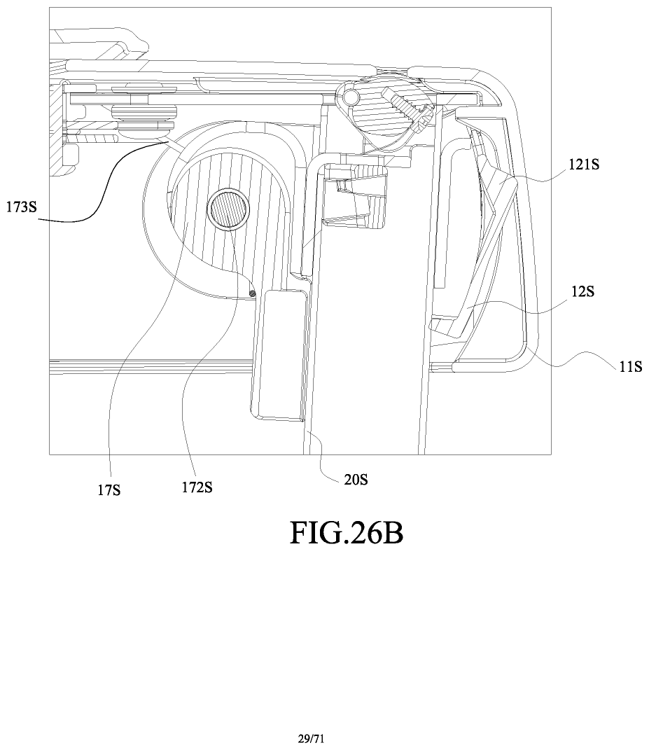

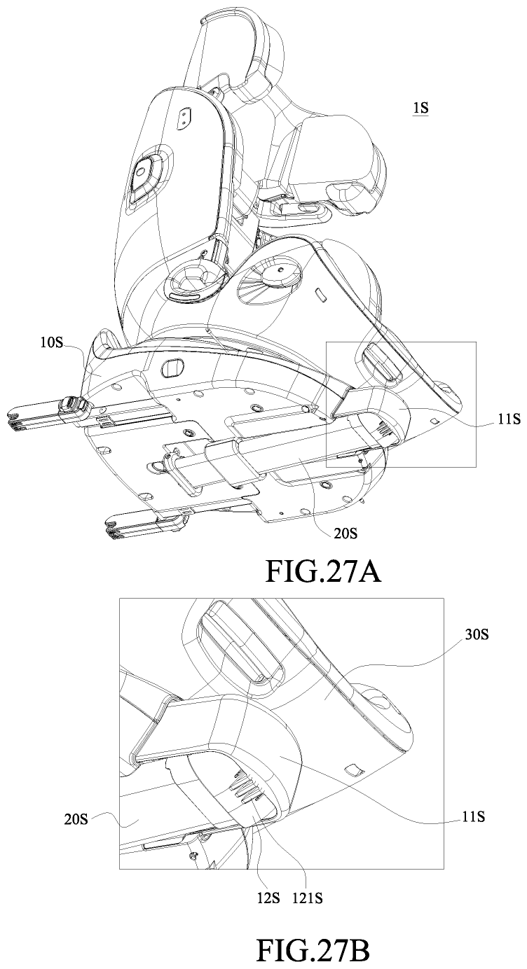

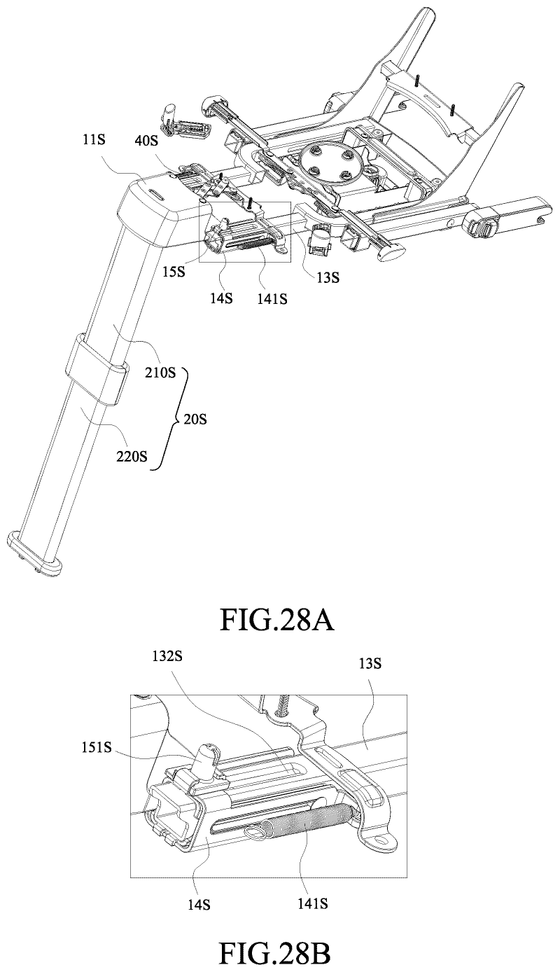

FIG. 24A is a cross-sectional view taken along a line A-A in FIG. 22 of an embodiment of the present disclosure. FIG. 24B is a partial enlarged view of FIG. 24A. FIG. 25A is a cross-sectional view similar to FIG. 24A, with the supporting leg of FIG. 25A in a position of being unfolded and extended. FIG. 25B is a partial enlarged view of FIG. 25A. FIG. 26A is a cross-sectional view similar to FIG. 24A, with the supporting leg of FIG. 26A in a completely unfolded and extended position. FIG. 26B is a partial enlarged view of FIG. 26A. FIG. 27A is a perspective view of the carrier according to an embodiment of the present disclosure, in which the supporting leg is in the position of being unfolded and extended. FIG. 27B is a partial enlarged view of FIG. 27A. FIG. 28A is a perspective view of the carrier of the present disclosure, in which a part of components are removed to show the internal structure. FIG. 28B is a partial enlarged view of FIG. 28A.

Referring to FIGS. 28A and 28B, the base 10S may include a fixing bracket 13S and a movable bracket 14S. The fixing bracket 13S may be fixed inside the base housing 18S. The movable bracket 14S may be sleeved on the fixing bracket 13S and may slide in the front-rear direction relative to the fixing bracket 13S. Both the fixing bracket 13S and the movable bracket 14S may be formed as symmetrical frame structures, but the present disclosure is not limited thereto. A restoring element 141S may be disposed between the movable bracket 14S and the base housing 18S. Specifically, two restoring elements 141S may be symmetrically disposed between the movable bracket 14S and the base housing 18S, and the number of restoring elements 141S is not limited herein. The restoring element 141S may apply a constant pulling force toward the front of the carrier IS to the movable bracket 14S. Alternatively, the restoring element 141S may be disposed between the fixing bracket 13S and the movable bracket 14S. The restoring element 141S may be a tension spring, but the present disclosure is not limited thereto. The first cover portion 11S may be disposed at the front of the movable bracket 14S, so as to perform a telescopic movement in the front-rear direction together with the movable bracket 14S. The supporting leg 20S and the second cover portion 12S may be pivotally connected to the front of the movable bracket 14S (see FIGS. 24A to 28B). That is, when the movable bracket 14S moves in the front-rear direction, the supporting leg 20S, the first cover portion 11S and the second cover portion 12S all move in the front-rear direction together with the movable bracket 14S. The carrier 1S may include a transfer structure 40S. The transfer structure 40S may be connected to the supporting leg 20S, the fixing bracket 13S and the movable bracket 14S, respectively, so that a movement of the movable bracket 14S relative to the fixing bracket 13S and the pivoting of the supporting leg 20S are simultaneously performed. The transfer structure 40S may be formed as a structure that can be extended and retracted, for example, a telescopic structure in which a plurality of rods are pivotally connected to each other to form a plurality of X-shaped units. One end of the transfer structure 40S may be connected to the fixing bracket, the other end of the transfer structure 40S may be connected to the movable bracket 14S, and a part between one end and the other end of the transfer structure 40S may be connected to the supporting leg 20S. The transfer structure 40S may be connected to the supporting leg 20S via, for example, a flexible rope or wire (not shown). The present disclosure does not limit a specific structure of the transfer structure 40S, and the transfer structure 40S only needs to have a function of synchronizing the unfolding of the supporting leg 20S with the forward movement of the movable bracket 14S. Since the transfer structure 40S is not the focus of the present disclosure, the transfer structure 40S will not be described in detail. The movable bracket 14S may also be provided with a locking element 15S (which will be described in detail below). The locking element 15S may be protrusively disposed on the movable bracket 14S.

Referring to FIGS. 24A to 27B, the supporting leg 20S may have a cam 17S. The cam 17S may pivot about the pivot shaft 172S. The supporting leg 20S, the fixing bracket 13S and the movable bracket 14S also pivot around the pivot shaft 172S. An elastic element 173S may be disposed on the pivot shaft 172S. The elastic element 173S may act on the movable bracket 14S and the supporting leg 20S respectively, so that the supporting leg 20S tends to pivot to the unfolded position. The elastic element 173S may be a torsion spring. When the supporting leg 20S is locked in the accommodating portion 181S, the supporting leg 20S may be released by actuating the locking button 185S. Due to an action of the restoring element 141S, the supporting leg 20S pivots counterclockwise, and at this time, the buffer portion 121S contacts a lower edge of the first cover portion 11S. Due to the blocking of the first cover portion 11S, the buffer portion 121S will be deformed, thereby providing resistance to the pivoting of the supporting leg 20S from the folded position to the unfolded position. Referring to FIG. 24B, a deformation space 123S may be formed on an inner side the second cover portion 12S. The deformation space 123S may be formed as a cavity to allow a deformation of the buffer portion 121S. When the supporting leg 20S further pivots, the buffer portion 121S abuts against the inner side of the first cover portion 11S and rubs against each other, thereby generating resistance. Such resistance will continue until the supporting leg 20S is completely unfolded (see FIGS. 27A and 27B). The magnitude of the resistance may be adjusted by adjusting the protrusion distance or number of the buffer portion 121S. For example, the resistance may be adjusted so that the supporting leg 20S is slowly unfolded, but the pivoting of the supporting leg 20S is not stopped. In other words, the buffer portion 121S may provide buffering for the pivoting of the supporting leg 20S.

When the supporting leg 20S changes from a state shown in FIG. 24A and FIG. 24B to a state shown in FIG. 25A and FIG. 25B, the buffer portion 121S does not abut against the first cover portion 11S. In this way, the supporting leg 20S may be accelerated unimpeded from stationary to a certain speed. That is to say, the buffer portion 121S is only used to avoid the supporting leg 20S from pivoting too quickly, and does not always hinder the pivoting of the supporting leg 20S from beginning to end. Such a structure can shorten the time required for unfolding the supporting leg 20S.

Alternatively, the base 10S may not include the movable bracket 14S. At this time, the supporting leg 20S, the first cover portion 11S and the second cover portion 12S may be disposed on the fixing bracket 13S. That is, the supporting leg 20S can only pivot relative to the fixing bracket 13S and cannot slide in the front-rear direction.

Alternatively, the supporting leg 20S may be fixedly disposed on the movable bracket 14S, so that the supporting leg 20S can only slide in the front-rear direction and cannot pivot.

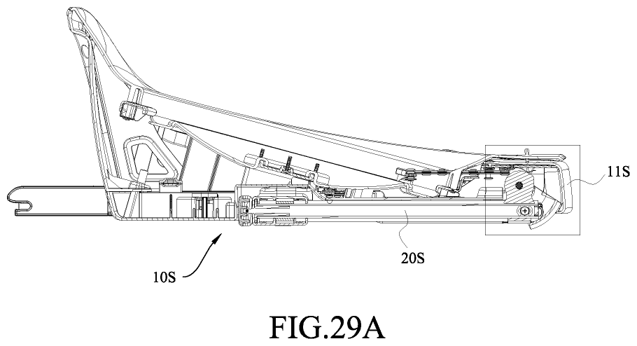

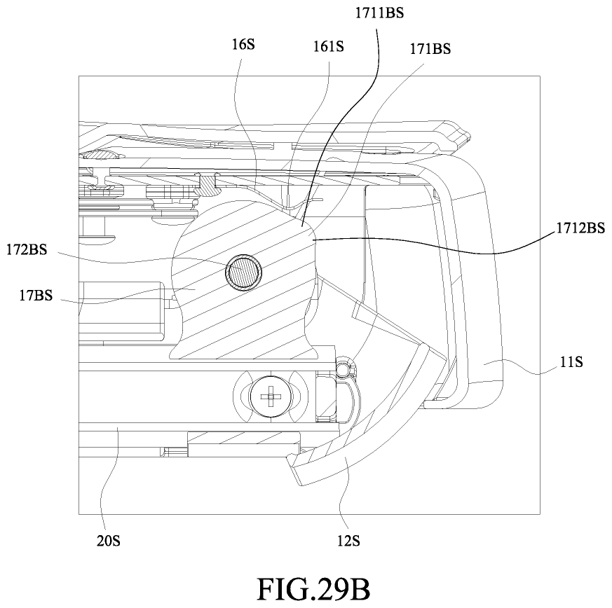

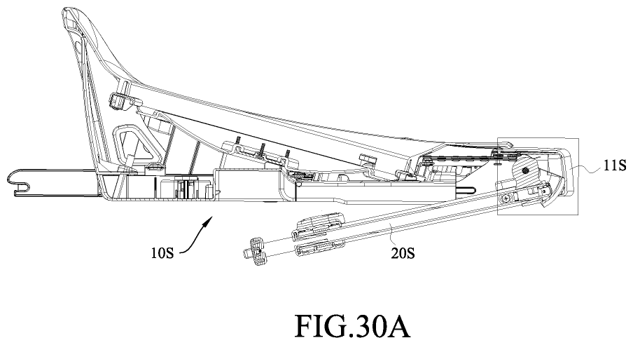

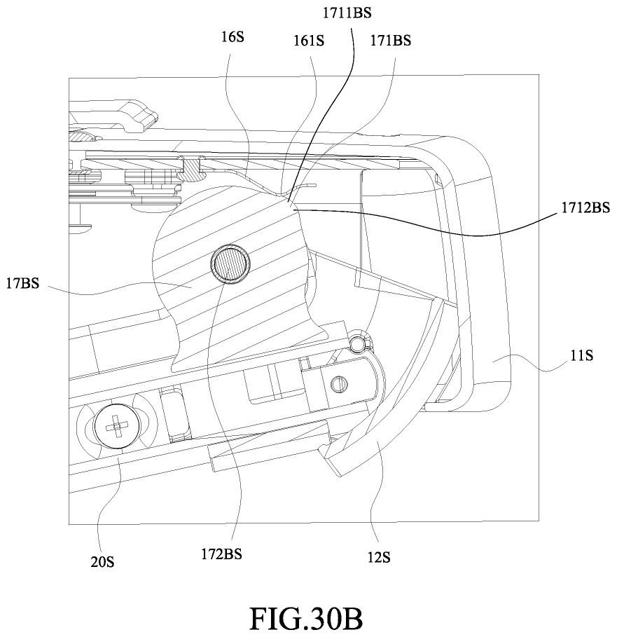

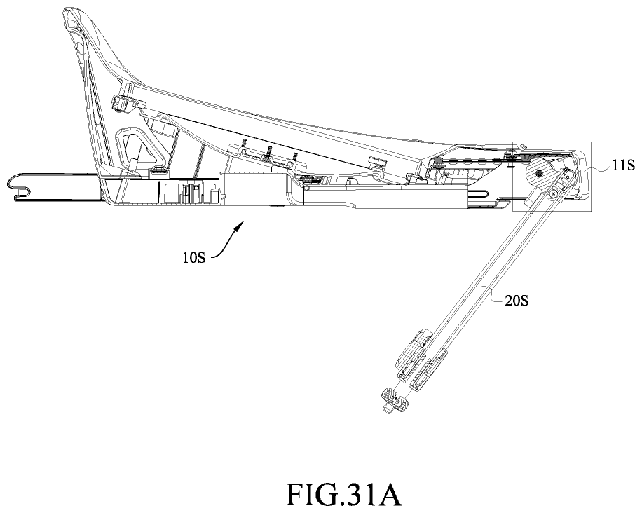

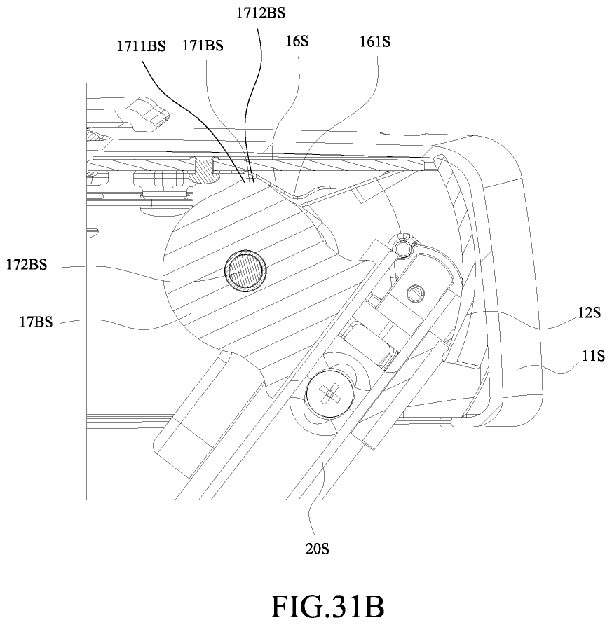

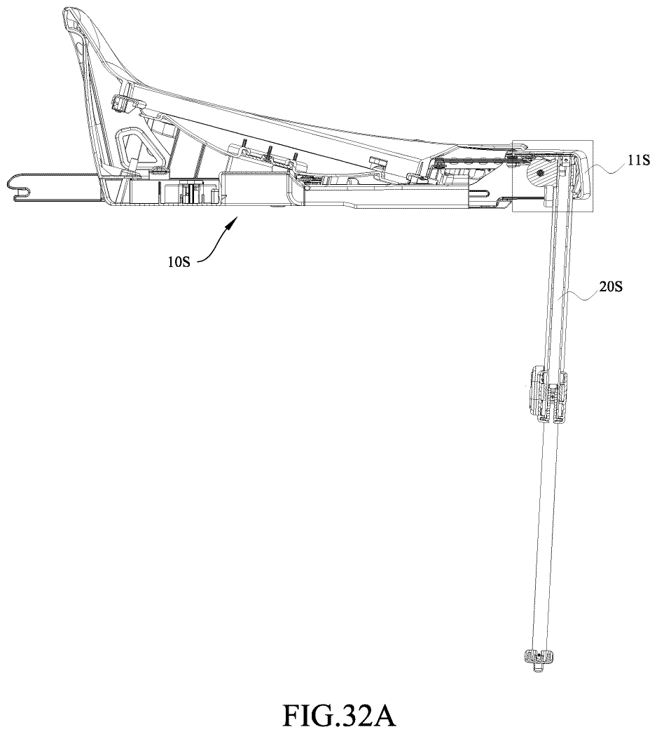

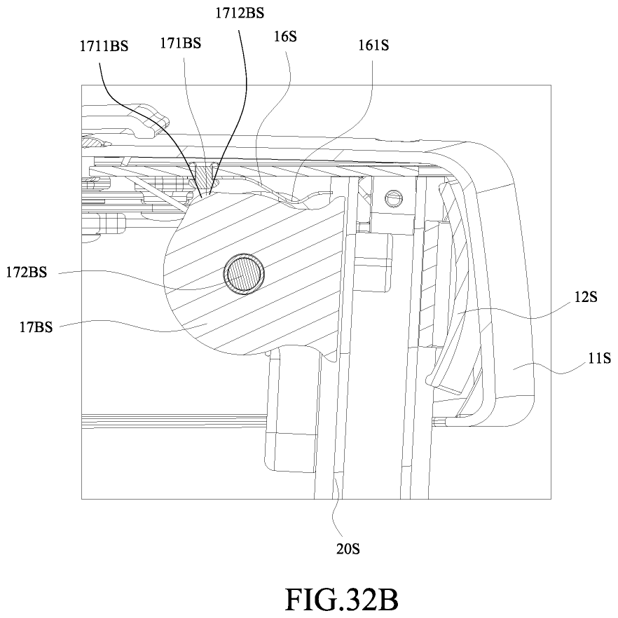

FIG. 29A is a cross-sectional view taken along the line A-A in FIG. 22 of another embodiment of the present disclosure. FIG. 29B is a partial enlarged view of FIG. 29A. FIG. 30A is a cross-sectional view similar to FIG. 29A, with the supporting leg of FIG. 30A in the position of being unfolded and extended. FIG. 30B is a partial enlarged view of FIG. 30A. FIG. 31A is a cross-sectional view similar to FIG. 29A, with the supporting leg of FIG. 31A in a further unfolded and extended position. FIG. 31B is a partial enlarged view of FIG. 31A. FIG. 32A is a cross-sectional view similar to FIG. 29A, with the supporting leg of FIG. 31A in the completely unfolded and extended position. FIG. 32B is a partial enlarged view of FIG. 32A.

The same parts of this embodiment as those of the previous embodiments will not be described in detail again.

Referring to FIGS. 29A to 32B, a protrusion 171BS may be formed on the cam 17BS. Two sides of the protrusion 171BS are a first protruding surface 1711BS and a second protruding surface 1712BS, respectively. The carrier 1S may include a buffer portion 16S. The buffer portion 16S may be fixed to an inner wall of the base 10S and located above the cam 17BS. Specifically, a rear end (the left end in FIG. 29B) of the buffer portion 16S may be fixed to the inner wall of the base 10S. Alternatively, a front end of the buffer portion 16S may be fixed to the inner wall of the base 10S. A protrusion 161S may be formed on the buffer portion 16S. The protrusion 161S protrudes generally downward to face the cam 17BS. When the supporting leg 20S pivots counterclockwise, the protrusion 171BS will contact the protrusion 161S to provide resistance. That is, the buffer portion 16S provides resistance to the pivoting of the supporting leg 20S via the cam 17BS. The resistance may be adjusted so that the supporting leg 20S is slowly unfolded, but the pivoting of the supporting leg 20S is not stopped. Specifically, when the supporting leg 20S is unfolded, the first protruding surface 1711BS contacts with the protrusion 161S (as shown in FIG. 30B) to provide resistance. When the supporting leg 20S is further unfolded, the second protruding surface 1712BS contacts with the protrusion 161S (as shown in FIG. 31B), so that the protrusion 161S promotes an unfolding movement of the supporting leg 20S.

The buffer portion 16S may be a sheet with elasticity, for example, a metal sheet, a plastic sheet, and the like. The protrusion 161S may be formed by bending the buffer portion 16S, and the present disclosure is not limited thereto. The buffer portion 16S may be formed as a bent structure and has elasticity. Although FIGS. 29A to 32B show one buffer portion 16S, and the buffer portion 16S has one protrusion 161S. Alternatively, the carrier 1S may include two or more buffer portions 16S. Alternatively, the buffer portion 16S may include two or more protrusions 161S.

In this embodiment, there may be no buffer portion 121S on the second cover portion 12S.

Alternatively, both the buffer portion 16S of this embodiment and the buffer portion 16S of the previous embodiment may exist on the carrier 1S.

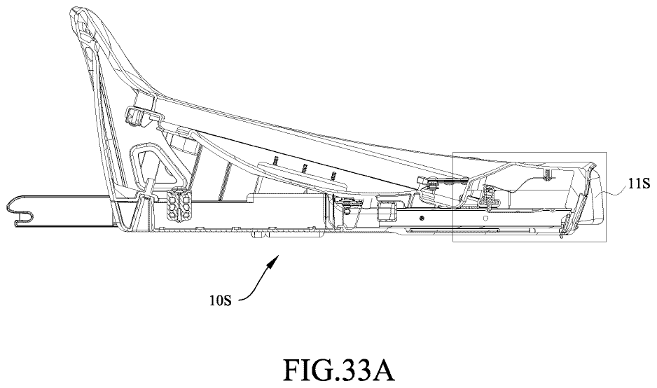

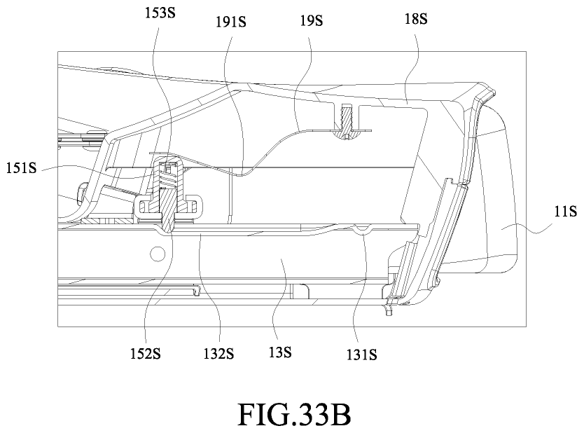

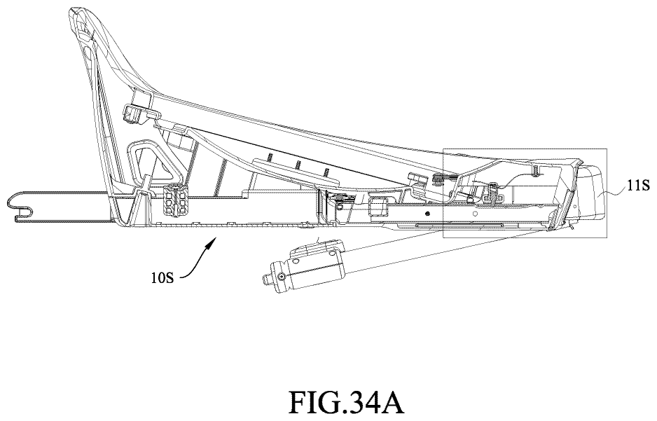

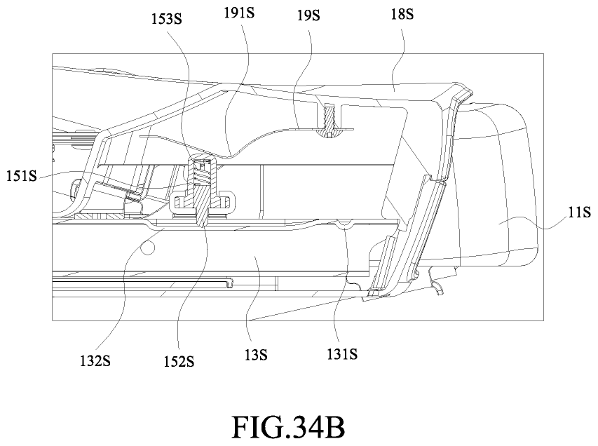

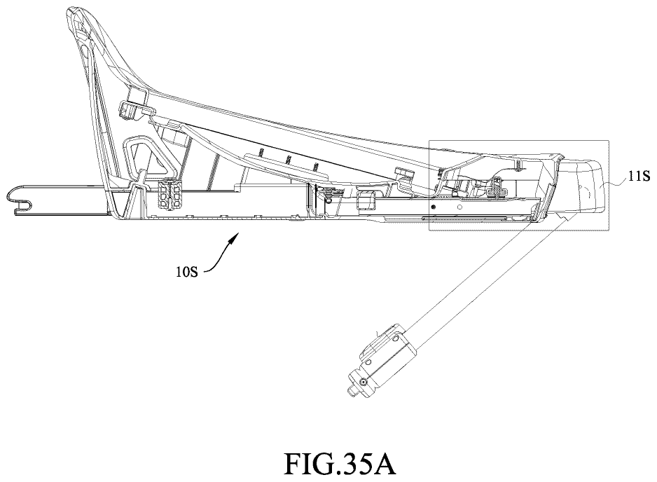

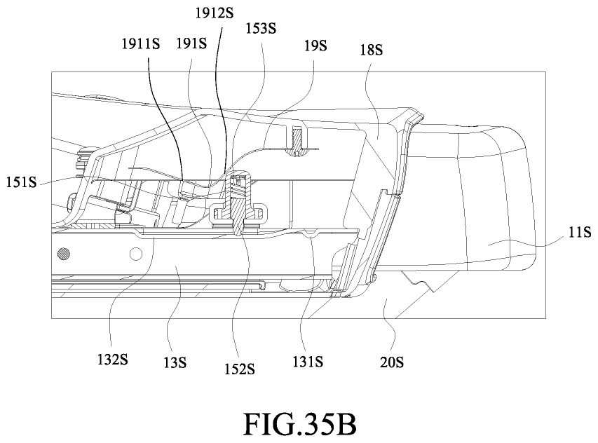

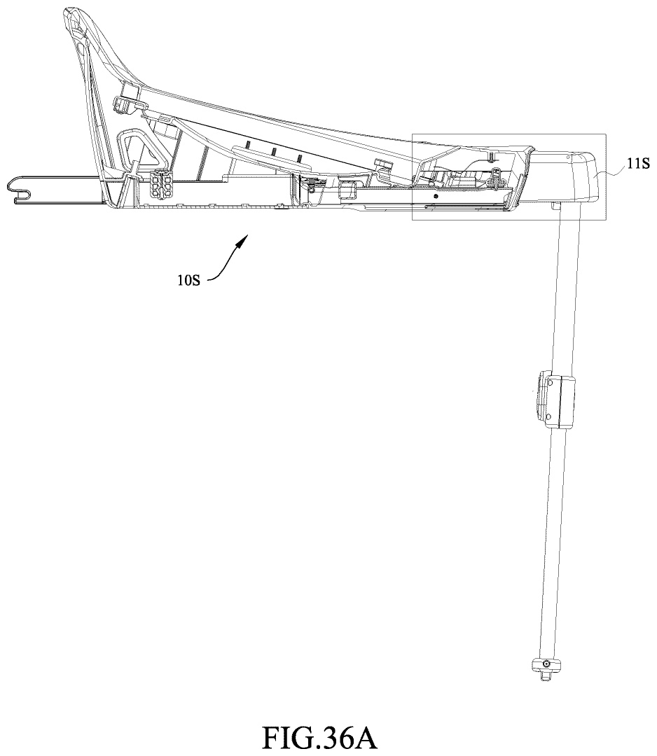

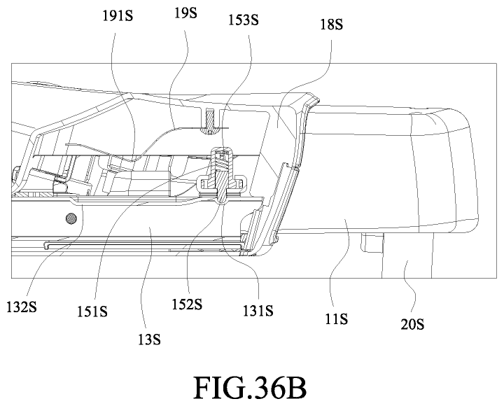

FIG. 33A is a cross-sectional view taken along a line B-B in FIG. 22 of yet another embodiment of the present disclosure. FIG. 33B is a partial enlarged view of FIG. 33A. FIG. 34A is a cross-sectional view similar to FIG. 33A, with the supporting leg of FIG. 34A in the position of being unfolded and extended. FIG. 34B is a partial enlarged view of FIG. 34A. FIG. 35A is a cross-sectional view similar to FIG. 33A, with the supporting leg of FIG. 35A in the further unfolded and extended position. FIG. 35B is a partial enlarged view of FIG. 35A. FIG. 36A is a cross-sectional view similar to FIG. 33A, with the supporting leg of FIG. 36A in the completely unfolded and extended position. FIG. 36B is a partial enlarged view of FIG. 36A.

The same parts of this embodiment as those of the previous embodiment will not be described in detail again.

Referring to FIGS. 33A to 36B, the fixing bracket 13S may have a locking hole 131S and a groove 132S. The locking hole 131S and the groove 132S are both formed on an upper surface of the fixing bracket 13S, and may be disposed at intervals. The groove 132S may be elongated. The carrier 1S may include a buffer element 19S. The buffer element 19S may be fixed in the base housing 18S. For example, the buffer element 19S may be fixed to the inner wall of the base 10S and located above the locking element 15S. Specifically, the front end (the right end in FIG. 33B) of the buffer element 19S may be fixed to the inner wall of the base 10S. Alternatively, the rear end of the buffer element 19S may be fixed to the inner wall of the base 10S.

The locking element 15S may include a locking seat 151S, a locking pin 152S and a driving element 153S. A cavity may be formed inside the locking seat 151S. The locking pin 152S is telescopically disposed in the cavity formed by the locking seat 151S and abuts against the fixing bracket 13S. A shape of the cavity corresponds to a shape of the locking pin 152S, so that the locking pin 152S can slide up and down in the cavity. The driving element 153S may be disposed in the locking seat 151S and above the locking pin 152S. The driving element 153S abuts against the locking pin 152S and the locking seat 151S, respectively, thereby applying a constant downward force to the locking pin 152S. When the locking element 15S moves relative to the fixing bracket 13S along with the movable bracket 14S (i.e., when the first cover portion 11S, the second cover portion 12S and the supporting leg 20S extend towards the front of the base 10S), the locking pin 152S is pushed by the driving element 153S and abuts against the groove 132S to generate resistance. The resistance reduces a moving speed of the movable bracket 14S, but does not stop the movable bracket 14S. The resistance can prevent the first cover portion 11S from generating excessive impact force and causing damage to people or articles in front of the carrier 1S. The movable bracket 14S will continue to move forward after passing through the groove 132S until the locking pin 152S falls into the locking hole 131S. At this time, the supporting leg 20S pivots to a state of being substantially perpendicular to the ground. The driving element 153S may be a spring, but the present disclosure is not limited thereto.

During a movement of the movable bracket 14S relative to the fixing bracket 13S, the buffer element 19S may abut against the locking seat 151S, thereby generating resistance to the movement of the movable bracket 14S. The resistance reduces the moving speed of the movable bracket 14S, but does not stop the movable bracket 14S. Specifically, the buffer element 19S may abut against the top of the locking seat 151S. A protrusion 191S may be formed on the buffer element 19S. The protrusion 191S protrudes generally downward to face the locking seat 151S. When the fixing bracket 13S moves, the protrusion 191S will contact the locking seat 151S to provide variable resistance. In other words, when the protrusion 191S contacts the locking seat 151S, the movable bracket 14S will receive a maximum resistance.

The protrusion 191S may be similar to the cam 17BS of the buffer portion 16S. That is, when one side (i.e., the left side in FIGS. 33B, 34B, 35B and 36B) of the buffer element 19S abuts against the top of the locking seat 151S, the buffer element 19S generates resistance to the top of the locking seat 151S. When the other side (i.e., the right side in FIGS. 33B, 34B, 35B and 36B) of the buffer element 19S abuts against the top of the locking seat 151S, the buffer element 19S generates a thrust force on the top of the locking seat 151S to promote the movable bracket 14S to extend out.

The buffer element 19S may be a sheet with elasticity (or referred to “an elastic sheet”), for example, a metal sheet, a plastic sheet, etc. The buffer element 19S may be formed with a protrusion 191S for abutting against the locking seat 151S. As shown in FIG. 35B, the protrusion 191S may include a first surface 1911S and a second surface 1912S connecting the first surface 1911S. An included angle between the second surface 1912S and a horizontal direction may be greater than an included angle between the first surface 1911S and the horizontal direction. When the locking element 15S abuts against the first surface 1911S, the buffer element 19S may apply a thrust force toward the retracted position to the locking element 15S. When the locking element 15S abuts against the second surface 1912S, the buffer element 19S may apply a thrust force toward the extended position to the locking element 15S. The protrusion 191S may be formed by bending the buffer element 19S, and the present disclosure is not limited thereto. The buffer element 19S may be formed into a bent structure and has elasticity. Although FIGS. 33 to 36 show one buffer element 19S, and the buffer element 19S has one protrusion 191S. Alternatively, the carrier 1S may include two or more buffer elements 19S. Alternatively, the buffer element 19S may include two or more protrusions 191S.

Although in this embodiment, the resistance is applied to the movable bracket 14S by the buffer element 19S and the fixing bracket 13S. It can be understood that the resistance may be applied to the movable bracket 14S by only one of the buffer element 19S and the fixing bracket 13S.

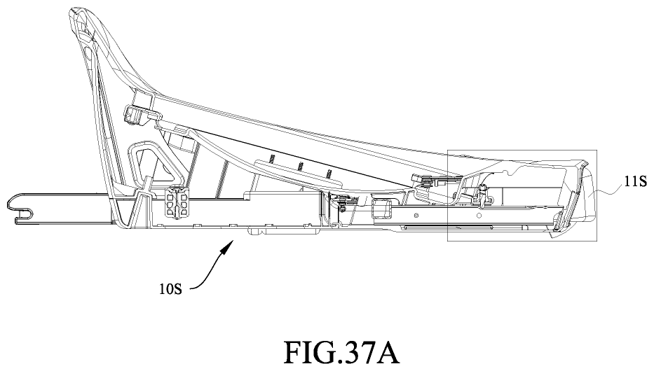

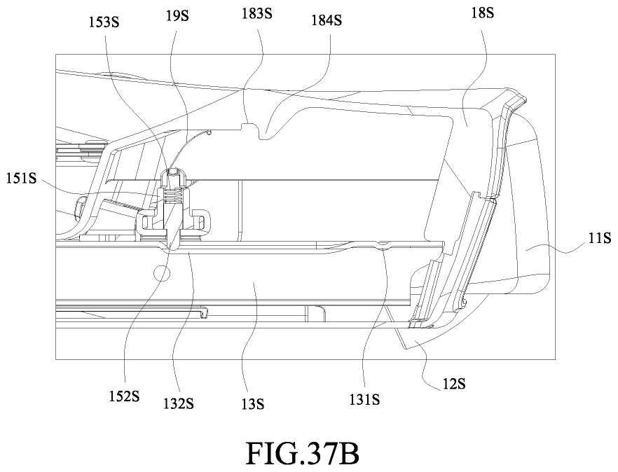

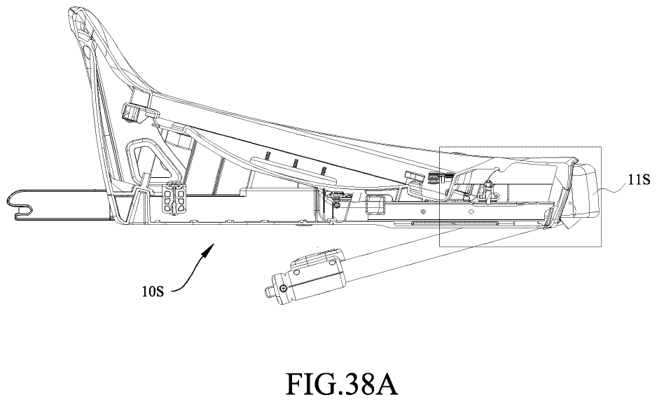

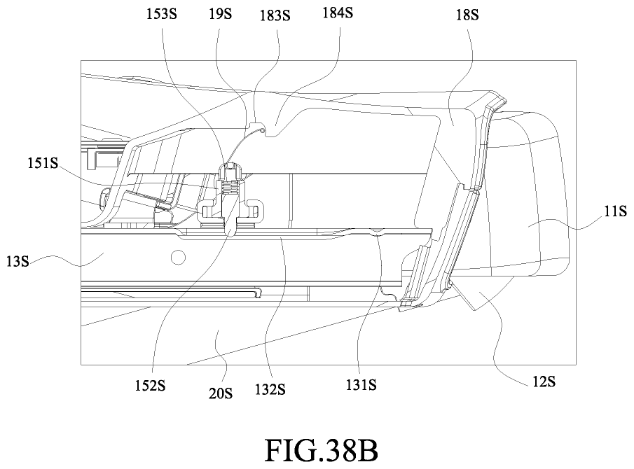

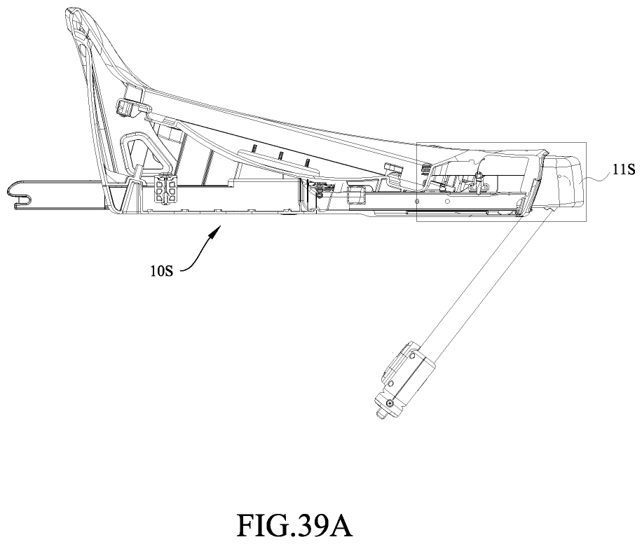

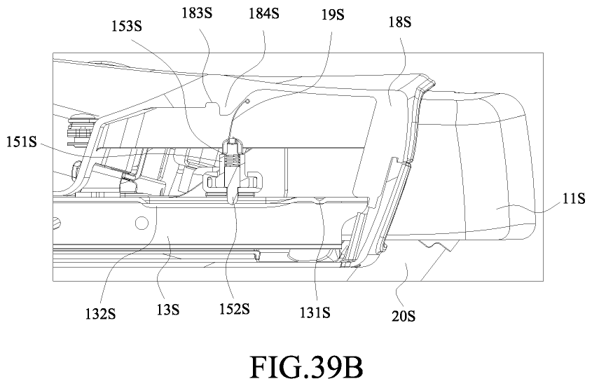

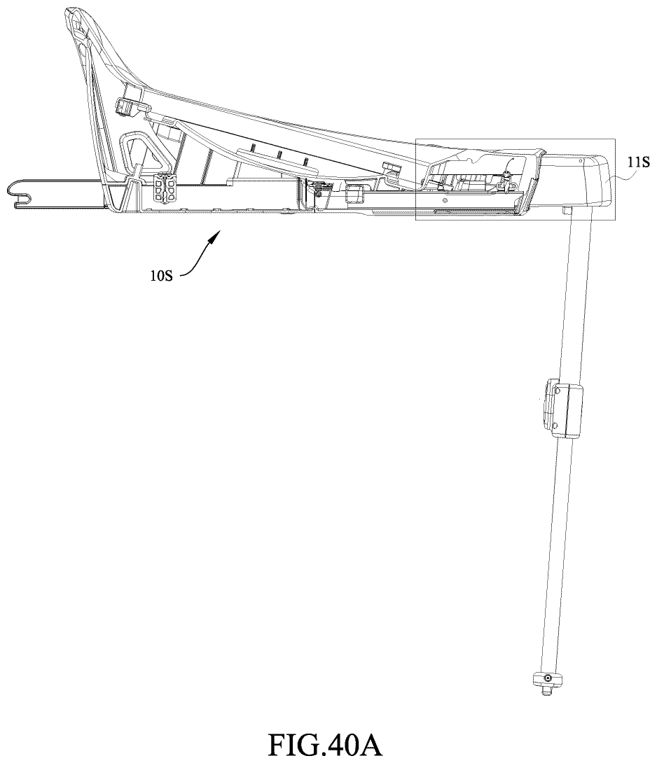

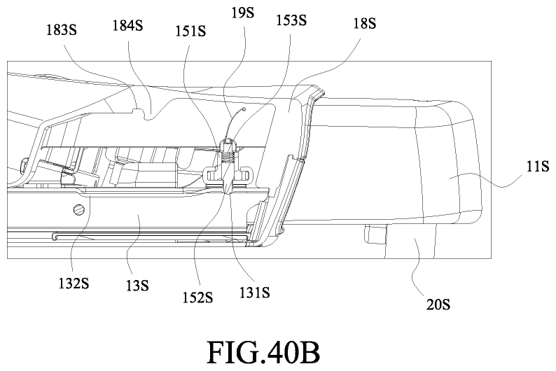

FIG. 37A is a cross-sectional view taken along the line B-B in FIG. 22 of yet another embodiment of the present disclosure. FIG. 37B is a partial enlarged view of FIG. 37A. FIG. 38A is a cross-sectional view similar to FIG. 37A, with the supporting leg of FIG. 38A in the position of being unfolded and extended. FIG. 38B is a partial enlarged view of FIG. 38A. FIG. 39A is a cross-sectional view similar to FIG. 37A, with the supporting leg of FIG. 39A in the further unfolded and extended position. FIG. 39B is a partial enlarged view of FIG. 39A. FIG. 40A is a cross-sectional view similar to FIG. 37A, with the supporting leg of FIG. 40A in a completely unfolded and extended position. FIG. 40B is a partial enlarged view of FIG. 40A.

The same parts of this embodiment as those of the previous embodiment will not be described in detail again.

Referring to FIGS. 37A to 40B, unlike the previous embodiment, one end of the buffer element 19S of this embodiment may be fixed at the top of the locking seat 151S. A blocking concave portion 183S and a blocking protrusion 184S may be formed on a top surface of the inside of the base housing 18S. The blocking concave portion 183S may be disposed at a rear side (i.e., the left side in FIG. 37B) of the blocking protrusion 184S. The other end (i.e., a free end) of the buffer element 19S may be formed as an arc surface or a circular ring. When the movable bracket 14S moves relative to the fixing bracket 13S, the other end of the buffer element 19S may contact the top surface of the inside of the base housing 18S, thereby generating resistance. When the other end of the buffer element 19S moves to the blocking concave portion 183S and abuts against the blocking protrusion 184S, the resistance applied by the base housing 18S to the movable bracket 14S via the buffer element 19S will reach the maximum. Similarly, the maximum resistance may only reduce the moving speed of the movable bracket 14S, but it cannot stop the movable bracket 14S. When the movable bracket 14S continues to move, the buffer element 19S is deformed and finally leaves the blocking concave portion 183S and the blocking protrusion 184S. During the movement of the movable bracket 14S from the retracted position to the extended position, after the free end of the buffer element 19S no longer abuts against the blocking protrusion 184S, the free end of the buffer element does not contact the base housing.

Although in this embodiment, the resistance is applied to the movable bracket 14S by the base housing 18S and the fixing bracket 13S, it can be understood that the resistance may be applied to the movable bracket 14S by only one of the base housing 18S and the fixing bracket 13S.

It can be seen that the pivoting of the supporting leg 20S of the carrier 1S of the present disclosure can be buffered, so as to prevent the supporting leg 20S from hitting people or articles around with relatively great energy when the supporting leg is unfolded. A forward movement of the first cover portion 11S and the supporting leg 20S can be buffered, so as to prevent the first cover portion 11S and the supporting leg 20S from hitting people or articles around with relatively great energy when they move forward.

At the same time, the present disclosure can change a variation curve of resistance by providing structures such as the protrusion 191S, the blocking concave portion 183S and the blocking protrusion 184S, so as to reasonably set the variation curve of resistance according to the speed change of the movements of the supporting leg 20S and the first cover portion 11S, to ensure that the movements of the supporting leg 20S and the first cover portion 11S meet an expected speed, and improve a running quality of the carrier 1S. For example, when the supporting leg 20S starts to be unfolded and/or extended, no resistance is set to allow the supporting leg 20S to unfold and/or extend rapidly. When the supporting leg 20S is unfolded and/or extended to a certain position or speed, resistance is set to avoid the supporting leg 20S from being unfolded and/or extended too quickly and resulting in impact and noise.

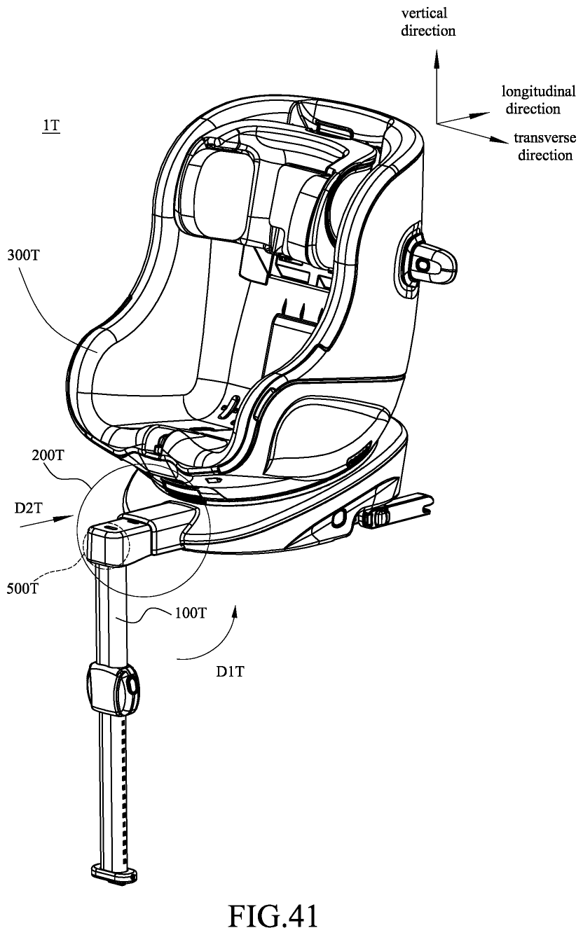

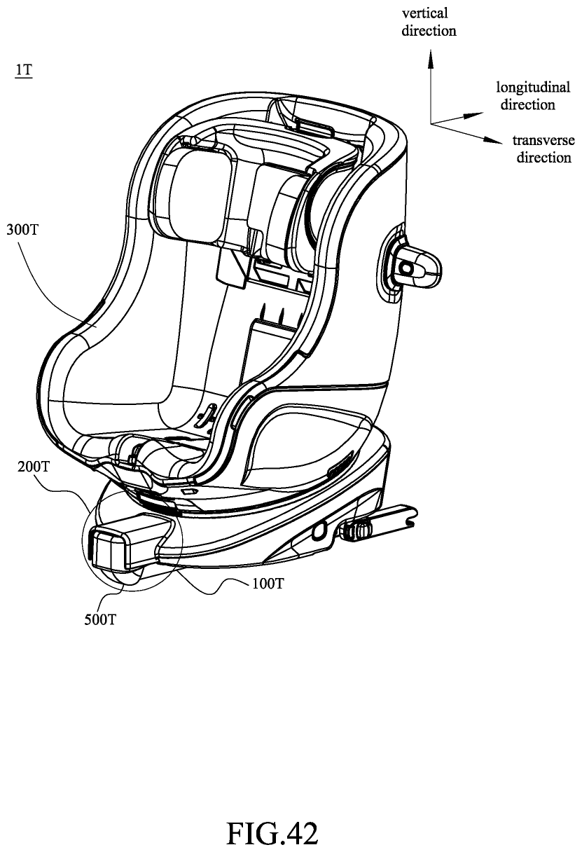

Referring to FIGS. 41 and 42, a carrier 1T according to the present disclosure is described as a whole. The carrier IT is described as a carrier in the present disclosure, however, it should be understood that the carrier IT may also be in any other suitable form having a supporting leg 100T. The carrier IT includes a body 300T, a supporting leg 100T, a supporting leg telescopic mechanism 200T, and an anti-pinch hand rotating mechanism 500T.

The body 300T is a part for a rider to ride. For the convenience of description, a longitudinal direction, a transverse direction and a vertical direction are defined herein based on the common usage method of the body 300T. The body 300T shown in FIGS. 41 and 42 includes a carrier and a base that may be separated from the seat portion. However, it should be understood that the body 300T may take any suitable form, for example, the body 300T may only include the base, and the body 300T may also include a combination of the base and an infant basket, the base and a sleeping basket, and the like.

The supporting leg 100T is disposed in front of a lower part of the body 300T for supporting the body 300T to the ground (not shown). A longitudinal end (i.e., the rear end) of the supporting leg telescopic mechanism 200T is connected to the body 300T, and the other longitudinal end (i.e., the front end) of the supporting leg telescopic mechanism 200T is connected to the supporting leg 100T. The supporting leg telescopic mechanism 200T can change its length in the longitudinal direction, so as to drive the supporting leg 100T to move in the longitudinal direction, that is, in a retracting direction D2T shown in FIG. 41 or an opposite direction thereof.

The anti-pinch hand rotating mechanism 500T is disposed between the supporting leg 100T and the supporting leg telescopic mechanism 200T. The anti-pinch hand rotating mechanism 500T allows the supporting leg 100T to rotate around a transverse axis relative to the supporting leg telescopic mechanism 200T, that is, in a folding direction DIT shown in FIG. 41 or an opposite direction thereof.

The supporting leg 100T may be switched between a state shown in FIG. 41 and a state shown in FIG. 42 through the supporting leg telescopic mechanism 200T and the anti-pinch hand rotating mechanism 500T. Because the supporting leg 100T has two modes of movement: a longitudinal movement and a rotation around the transverse axis, for the convenience of understanding, a state that the supporting leg 100T extends to the front of the body 300T as shown in FIG. 41 is called an extended state, and a state that the supporting leg 100T extends vertically as shown in FIG. 41 is called the extended state. A state that the supporting leg 100T as shown in FIG. 42 retracts into the body 300T is called a retracted state, and a state that the supporting leg 100T extends vertically as shown in FIG. 42 is called a folded state.

It can be seen that when the supporting leg 100T is in the retracted state and in the folded state, the space occupied by the supporting leg 100T is reduced to the greatest extent, so it is convenient to transport the carrier 1T.

In addition, the supporting leg 100T itself has a length that may be shortened, thus further reducing its occupied space, but this is not the focus therein.

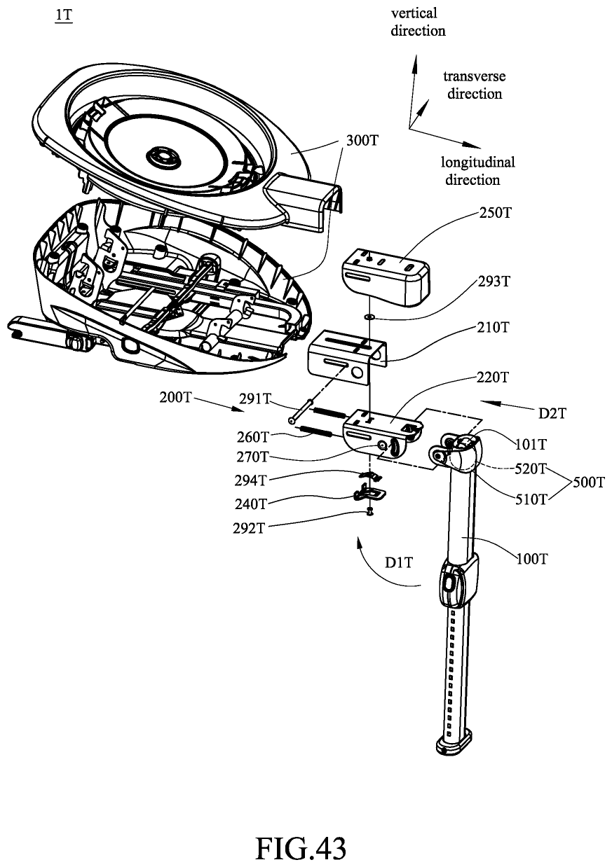

Referring to FIG. 43, components of the carrier 1T of the present disclosure will be generally described.

The supporting leg telescopic mechanism 200T includes a fixed sliding frame 210T (also called a first sliding frame), a movable sliding frame 220T (also called a second sliding frame), a locking element 240T, a decorative cover 250T, an auxiliary elastic element 260T, a pivot shaft 270T, a sliding pin 291T (also called a connecting element), a limiting pin 292T, a limiting spacer 293T and an elastic element 293T.

In the application of the present disclosure, the first sliding frame is the fixed sliding frame 210T mounted to the main body 300T, and the second sliding frame is the movable sliding frame 220T pivotally connected to the supporting leg 100T. However, the present disclosure is not limited thereto, and both the first sliding frame and the second sliding frame may be mounted to a movable component or a fixed component. The fixed sliding frame 210T and the movable sliding frame 220T are in sliding fit with each other through a connecting element (i.e., the sliding pin 291T) to adjust a spacing length between the supporting leg 100T and the body 300T. The spacing length is a spacing length from a pivot point between the supporting leg 100T and the movable sliding frame 220T to the body 300T. In this embodiment, the connecting element may be a single sliding pin 291T penetrating through the fixed sliding frame 210T and the movable sliding frame 220T in the transverse direction, or two sliding pins 291T (not shown) respectively disposed at two transverse sides of the fixed sliding frame 210T and the movable sliding frame 220T. Furthermore, it should be understood that in other embodiments, the connecting element may also be provided in other appropriate forms, such as a slide rail, a sliding block, a telescopic connecting rod, etc., as long as it can support the longitudinal movement of the fixed sliding frame 210T relative to the movable sliding frame 220T. Alternatively, the connecting element may also be movably connected to the fixed sliding frame 210T and the movable sliding frame 220T in other ways, such as a pivotal connection. For example, the connecting element is a rod-shaped body extending along the moving direction, and the fixed sliding frame 210T and the movable sliding frame 220T are pivotally connected to both ends of the connecting element respectively. When the connecting element pivots 180 degrees relative to the fixed sliding frame 210T and the movable sliding frame 220T respectively, a spacing length between the supporting leg 100T and the body 300T corresponding to a length of the connecting element in the sliding direction will be adjusted. Alternatively, the connecting element may also be a movable sliding frame sleeved between the first sliding frame and the second sliding frame respectively.

The fixed sliding frame 210T is installed in a longitudinal front of the body 300T. The movable sliding frame 220T is slidably connected to the fixed sliding frame 210T in the longitudinal direction through the sliding pin 291T. The decorative cover 250T covers above the movable sliding frame 220T and may be sandwiched between the fixed sliding frame 210T and the movable sliding frame 220T to form a sandwich structure. The limiting pin 292T is disposed to the movable sliding frame 220T, and is slidably inserted into the limiting groove 212T of the fixed sliding frame 210T in the longitudinal direction. The limiting spacer 293T is disposed at an end of the limiting pin 292T and abuts against a top of the limiting groove 212T to prevent the limiting pin 292T from vertically separating from the limiting groove 212T.

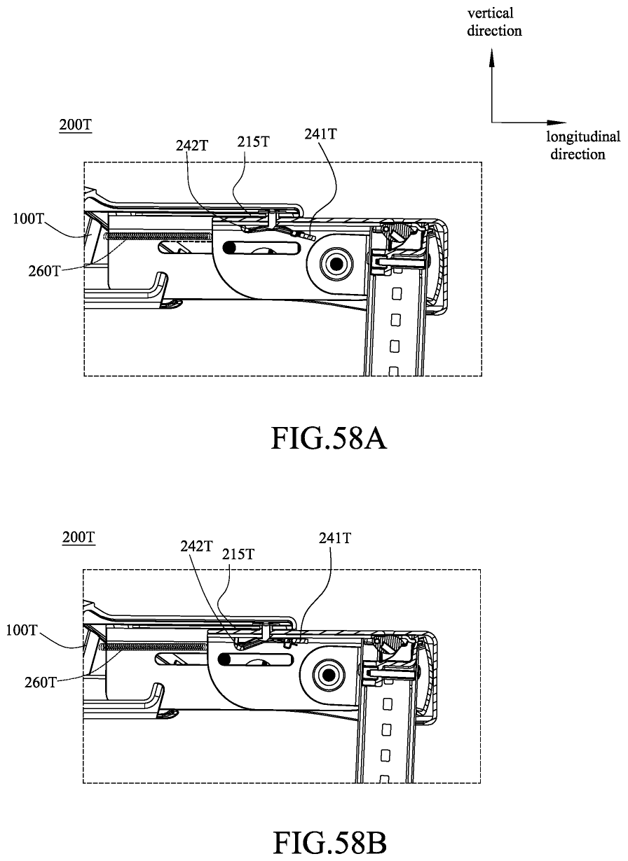

The locking element 240T is disposed in the movable sliding frame 220T and may be engaged to the fixed sliding frame 210T to lock a relative position of the fixed sliding frame 210T and the movable sliding frame 220T. An elastic element 294T is disposed on the locking element 240T to bias the locking element 240T into engagement with the fixed sliding frame 210T. The auxiliary elastic element 260T is disposed between the body 100T and the movable sliding frame 220T (see FIGS. 58A and 58B), and biases the movable sliding frame 220T to the extended state (i.e., located at a front end of the fixed sliding frame 210T). In other embodiments, the locking element 240T may also be disposed in the fixed sliding frame 220T and may be engaged to the movable sliding frame 210T to lock the relative position of the fixed sliding frame 210T and the movable sliding frame 220T.

The supporting leg 100T is connected to the front end of the movable sliding frame 220T through the anti-pinch hand rotating mechanism 500T, specifically to a pivot shaft 270T transversely disposed in the movable sliding frame 220T. The anti-pinch hand rotating mechanism 500T includes an anti-pinch cover 510T and a mounting seat 520T located inside the anti-pinch cover 510T. When the supporting leg 100T is in the folded position, the anti-pinch cover 510T will cover a gap between the supporting leg 100T and the supporting leg telescopic mechanism 200T, which will be described in detail later. The top end of the supporting leg 100T has a ground contacting indicator 101T, which can be observed through the decorative cover 250T to show whether the bottom end of the supporting leg 100T contacts with the ground. The ground contacting indicator 101T is not the focus of discussion herein, so the detailed description thereof is omitted.

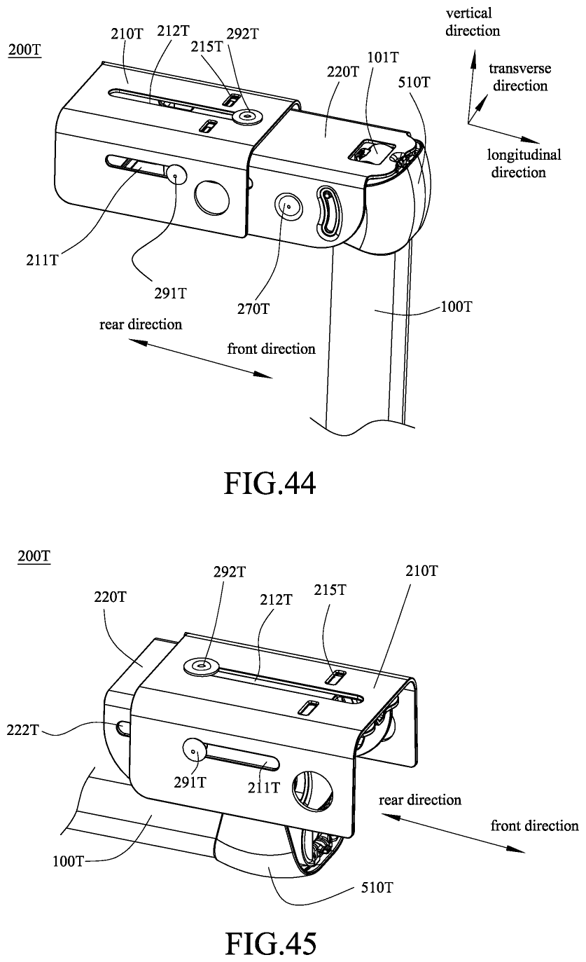

Referring to FIG. 44 and FIG. 45, the supporting leg telescopic mechanism 200T according to the present disclosure is further described.

The fixed sliding frame 210T and the movable sliding frame 220T may move relative to each other in the longitudinal direction so that the supporting leg telescopic mechanism 200T may be switched between the extended state and the retracted state. FIG. 44 shows the extended state, in which the movable sliding frame 220T is located at the front end of the fixed sliding frame 210T. FIG. 45 shows the retracted state, in which the movable sliding frame 220T is located at a rear end of the fixed sliding frame 210T. The relative movement of the fixed sliding frame 210T and the movable sliding frame 220T is not less than a longitudinal dimension of the fixed sliding frame 210T or a longitudinal dimension of the movable sliding frame 220T.

With the relative sliding between the fixed sliding frame 210T and the movable sliding frame 220T, the supporting leg telescopic mechanism 200T is switched between the retracted state and the extended state. When the supporting leg telescopic mechanism 200T is in the retracted state shown in FIG. 45, there is a relatively small spacing length between the supporting leg 100T and the body 300T (not shown). When the supporting leg telescopic mechanism 200T is in the extended state shown in FIG. 44, there is a relatively large spacing length between the supporting leg 100T and the body 300T (not shown). It should be understood that if only the fixed sliding frame 210T or the movable sliding frame 220T is provided with a sliding groove, a length of the sliding groove is limited by a length of the fixed sliding frame 210T or the movable sliding frame 220T, so the relative movement of the fixed sliding frame 210T and the movable sliding frame 220T will be relatively short. In the present disclosure, the fixed sliding frame 210T includes a fixed sliding groove 211T extending in the longitudinal direction, and the movable sliding frame 220T includes a movable sliding groove 221T extending in the longitudinal direction, and the fixed sliding groove 211T and the movable sliding groove 221T are at least partially overlapped. The supporting leg telescopic mechanism 200T further includes the sliding pin 291T penetrating through the fixed sliding groove 211T and the movable sliding groove 221T. Thanks to the fixed sliding groove 211T (also called a first sliding groove) formed on the fixed sliding frame 210T, and the movable sliding groove 221T (also called a second sliding groove) formed on the movable sliding frame 220T, and the fixed sliding groove 211T and the movable sliding groove 221T connected by the sliding pin 291T, the relative moving stroke of the fixed sliding frame 210T and the movable sliding frame 220T is obviously increased.

In addition, the fixed sliding frame 210T is provided with the limiting groove 212T extending in the longitudinal direction, and the movable sliding frame 220T is provided with the limiting pin 292T, and the limiting pin 292T may be inserted into the limiting groove 212T in the longitudinal direction in a sliding manner. Through a cooperation of the limiting groove 212T and the limiting pin 292T, the fixed sliding frame 210T and the movable sliding frame 220T can slide stably relative to each other, thus avoiding the relative rotation or inclination between them.

More specifically, the fixed sliding groove 211T and the movable sliding groove 221T are respectively disposed at two transverse sides of the fixed sliding frame 210T and two transverse sides of the movable sliding frame 220T, and the sliding pin 291T penetrates through each fixed sliding groove 211T and each movable sliding groove 221T in the transverse direction. That is, the number of the fixed sliding groove 211T and the fixed sliding groove 211T are two respectively. The two fixed sliding grooves 211T are oppositely disposed on two transverse side walls of the fixed sliding frame 210T. The two movable sliding grooves 221T are oppositely disposed on two transverse side walls of the movable sliding frame 220T. In this embodiment, a sliding pin 291T passes through two fixed sliding grooves 211T and two movable sliding grooves 221T, thereby improving the synchronization of sliding between the left and right sides and improving a mechanical strength of the connection. In other embodiments, two sliding pins may also be provided. One sliding pin passes through one fixed sliding groove 211T and one movable sliding groove 221T on the left side in the transverse direction. The other sliding pin passes through one fixed sliding groove 211T and one movable sliding groove 221T on the right side in the transverse direction. The limiting groove 212T and the limiting pin 292T are located on top walls of the fixed sliding frame 210T and the movable sliding frame 220T, respectively. However, this is not necessary. In other embodiments, the fixed sliding groove 211T and the movable sliding groove 221T may be respectively disposed at two vertical sides of the fixed sliding frame 210T and two vertical sides of the movable sliding frame 220T, and the sliding pin 291T correspondingly extends vertically. The limiting grooves 212T may be disposed at two transverse sides of the fixed sliding frame 210T, and the limiting pins 292T extend transversely accordingly. The number of the fixed sliding groove 211T and the movable sliding groove 221T may be four or six respectively.

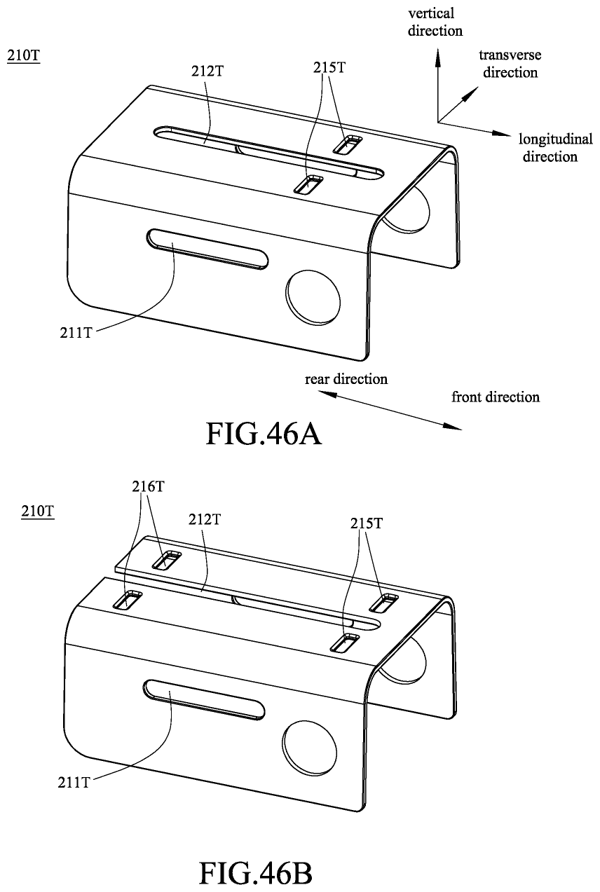

Referring to FIG. 46A, an embodiment of the fixed sliding frame 210T according to the present disclosure will be described in detail.

The fixed sliding frame 210T of this embodiment is generally in a shape of a three-sided enclosed housing extending in the longitudinal direction. More specifically, the fixed sliding frame 210T has a top wall and two side walls connected to two transverse sides of the top wall. Two fixed sliding grooves 211T are symmetrically formed on two side walls of the fixed sliding frame 210T and extend in the longitudinal direction respectively. The limiting groove 212T is formed on the top wall of the fixed sliding frame 210T and extends in the longitudinal direction. In this embodiment, two longitudinal ends of the limiting groove 212T do not extend beyond a range of the top wall, that is, the limiting groove 212T is a closed shape at both ends. At least one first locking hole 215T is formed on the top wall of the fixed sliding frame 210T. In this embodiment, two first locking holes 215T are disposed near the front end of the fixed sliding frame 210T (i.e., the right side in FIG. 46A) and distributed on two transverse sides of the limiting groove 212T. The first locking hole 215T is an elongated shape extending transversely, but this is not necessary, and the first locking hole 215T may be square or round.

As described above referring to FIGS. 44 and 45, the fixed sliding groove 211T and the limiting groove 212T are engaged to the sliding pin 291T and the limiting pin 292T, respectively. The positions of the fixed sliding groove 211T and the limiting groove 212T may also be interchanged, for example, the fixed sliding groove 211T may be disposed on a top wall and the limiting groove 212T may be disposed on a side wall.

Referring to FIG. 46B, another embodiment of the fixed sliding frame 210T according to the present disclosure will be described in detail.

The fixed sliding frame 210T of this embodiment is substantially the same as the fixed sliding frame 210T of the previous embodiment. The difference between the two is in that the limiting groove 212T of this embodiment extends to the outside of the fixed sliding frame 210T at the rear end (i.e. the left side in FIG. 46B), that is, the limiting groove 212T of this embodiment is in a shape of closed front end and open rear end. In the retracted state, the limiting pin 292T may slide out from the rear end of the limiting groove 212T, so that the sum of the lengths of the fixed sliding groove 211T and the movable sliding groove 221T may be greater than a length of the limiting groove 212T. In the extended state, an overlapping part of wall surfaces of the fixed sliding frame 210T and the movable sliding frame 220T is relatively small, transverse shaking or longitudinal rolling is easily generated between the sliding frames, and a cooperation between the limiting pin 292T and the limiting groove 212T may reduce the transverse shaking or longitudinal rolling between the sliding frames. In the retracted state, most of the wall surfaces of the fixed sliding frame 210T and the movable sliding frame 220T are overlapped, and even if the limiting pin 292T slides out of the rear end of the limiting groove 212T and no longer plays a limiting role, transverse shaking or longitudinal rolling between the fixed sliding frame 210T and the movable sliding frame 220T is not likely to occur. In this embodiment, a plurality of sets of first locking holes 215T are provided along the longitudinal direction of the fixed sliding frame 210T. The figure shows a set of first locking holes 215T near the front end of the fixed sliding frame 210T and a set of first locking holes 215T near the rear end of the fixed sliding frame 210T. However, it should be understood that more sets of the first locking holes 215T may be disposed in the longitudinal direction.

The first locking hole 215T is used to be fitted to the locking element 240T (see FIG. 43) to lock longitudinal relative positions of the fixed sliding frame 210T and the movable sliding frame 220T. In the case that a plurality of sets of first locking holes 215T are disposed in the longitudinal direction, it is allowed to lock the movable sliding frame 220T in a plurality of longitudinal positions relative to the fixed sliding frame 210T, including but not limited to the extended state and the retracted state.

It should be understood that the fixed sliding frame 210T of the above embodiment may be provided with a plurality of sets of first locking holes 215T in the longitudinal direction.

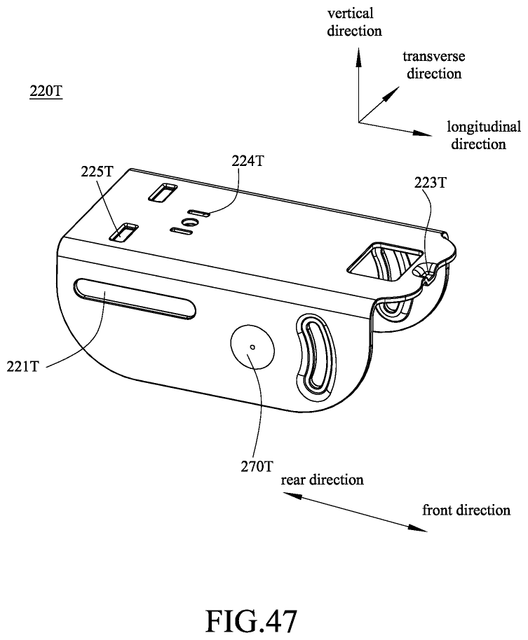

Referring to FIG. 47, the movable sliding frame 220T according to the present disclosure will be specifically described.

The movable sliding frame 220T is generally in a shape of a three-sided enclosed housing extending in the longitudinal direction. More specifically, the movable sliding frame 220T has a top wall and two side walls connected to two transverse sides of the top wall. A transverse dimension of the movable sliding frame 220T may be slightly smaller than a transverse dimension of the fixed sliding frame 210T so as to be enclosed inside the fixed sliding frame 210T. Two movable sliding grooves 221T are symmetrically formed on two side walls of the movable sliding frame 220T and extend in the longitudinal direction respectively. In this embodiment, the movable sliding groove 221T is located near the longitudinal rear end (i.e., the left side in FIG. 47) of the movable sliding frame 220T. It should be understood that the movable sliding groove 221T may also be located at other longitudinal positions of the movable sliding frame 220T, for example, near the longitudinal front end. In addition, the movable sliding groove 221T may also be disposed on the top wall of the movable sliding frame 220T, and the fixed sliding groove 211T is correspondingly disposed on the top wall of the fixed sliding frame 210T.

A second locking hole 225T is formed on the top wall of the movable sliding frame 220T. In this embodiment, two second locking holes 225T are disposed near a rear end of the movable sliding frame 220T and distributed transversely. A shape of each second locking hole 225T corresponds to a shape of each first locking hole 215T, that is, the shape of each second locking hole 225T may be an elongated shape extending transversely, or may be square or round.

A notch 224T is disposed on the top wall of the movable sliding frame 220T, for example, in a longitudinal front of the second locking hole 225T. The elastic element 294T is installed on the movable sliding frame 220T through the notch 224T, which will be described in detail later.

A front end of the top wall of the movable sliding frame 220T is further provided with a clamping groove 223T. The clamping groove 223T is provided in a vertically downward concave form. The clamping groove 223T is used to engage the mounting seat 520T when the supporting leg 100T is in the unfolded position, which will be described in detail below.

The pivot shaft 270T is transversely disposed between two side walls of the movable sliding frame 220T for pivotally connecting the supporting leg 100T to the movable sliding frame 220T, as shown in FIG. 43.

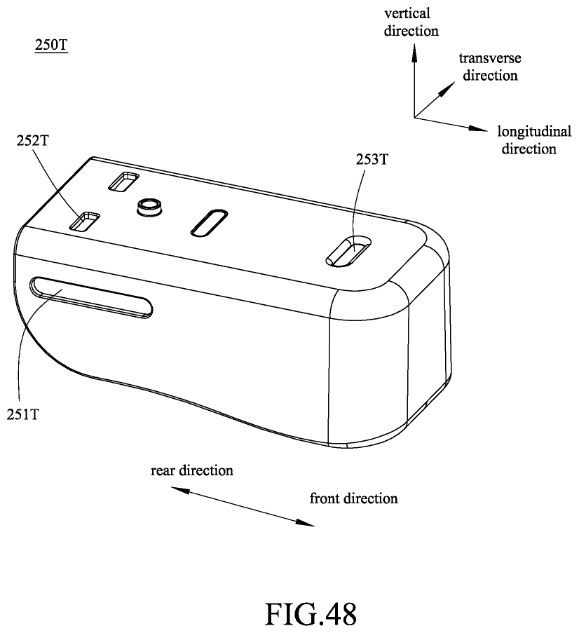

Referring to FIG. 48, the decorative cover 250T according to the present disclosure will be specifically described.

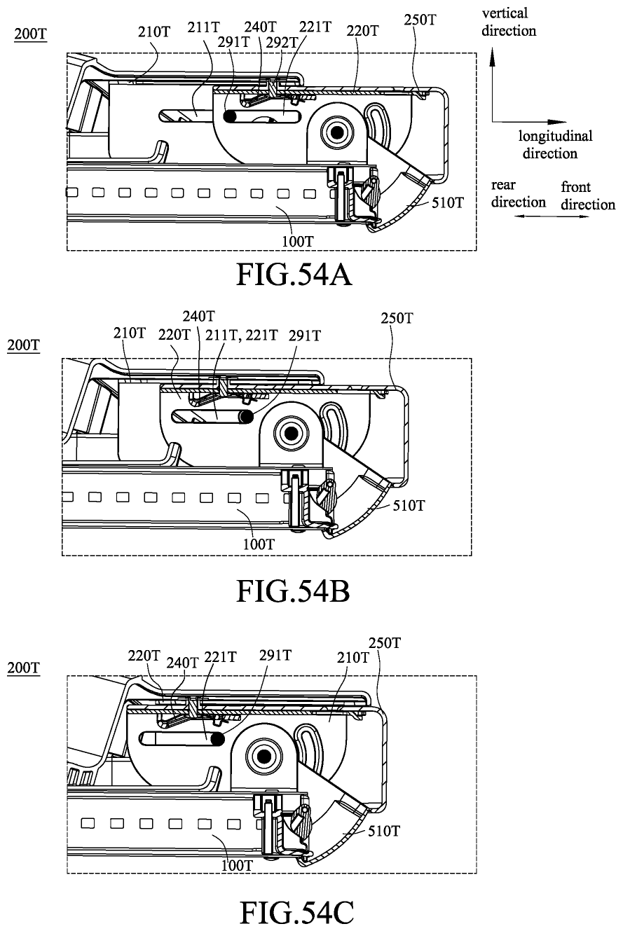

The decorative cover 250T is generally in a three-sided enclosed structure extending in the longitudinal direction and is closed at the front end. More specifically, the decorative cover 250T has a top wall, two side walls connected to two transverse sides of the top wall, and front walls connected at front ends of the top wall and the side walls. The decorative cover 250T covers the outside of the movable sliding frame 220T, and may be located between the fixed sliding frame 210T and the movable sliding frame 220T (see FIGS. 54A to 54C.).

A decorative cover hole 252T is formed in a top wall of the decorative cover 250T. In this embodiment, two decorative cover holes 252T are disposed near the rear end of the movable sliding frame 220T and distributed transversely. A shape of each decorative cover hole 252T corresponds to the shape of each first locking hole 215T and each second locking hole 225T, that is, the shape of each decorative cover hole 252T may be an elongated shape extending transversely, or may be square or round.

A front end of the top wall of the decorative cover 250T is provided with a window 253T to allow the user to observe the ground contacting indicator 101T through the window 253T. The ground contacting indicator 101T is not the focus herein, so the detailed description thereof is omitted.

A side wall of the decorative cover 250T may be provided with a decorative cover sliding groove 251T so that the sliding pin 291T passes through the decorative cover 250T.

It should be understood that the decorative cover 250T is not necessary to realize the main function of the supporting leg telescopic mechanism 200T. In some embodiments, the decorative cover 250T may be omitted.

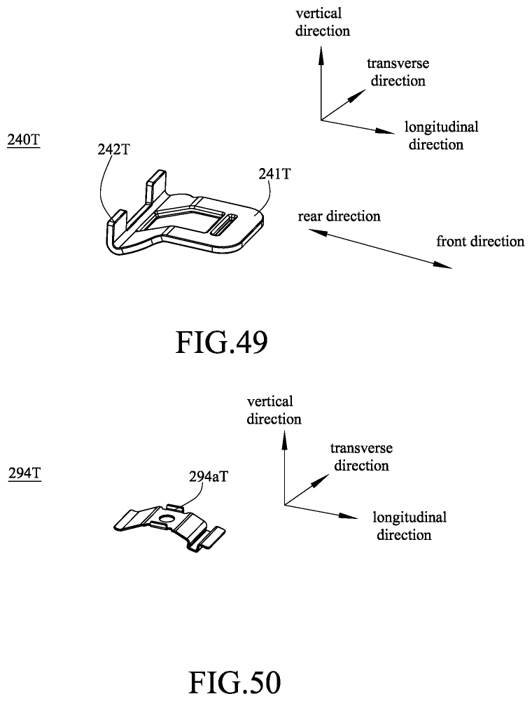

Referring to FIG. 49, the locking element 240T according to the present disclosure will be specifically described.

The locking element 240T is generally in a form of a sheet extending in the longitudinal direction and the transverse direction. A longitudinal end (i.e., the front end) of the locking element 240T is an unlocking portion 241T. The other longitudinal end (i.e., the rear end) of the locking element 240T is provided with at least one locking protrusion 242T. The locking protrusion 242T extends upward in the longitudinal direction. In this embodiment, two locking protrusions 242T are disposed in the transverse direction. In other embodiments, one locking protrusion 242T or more than two locking protrusions 242T may be provided.

In this embodiment, the locking protrusion 242T and the unlocking portion 241T are integrally formed. However, it should be understood that in other embodiments, the locking protrusion 242T and the unlocking portion 241T may also be provided as a plurality of components. For example, the unlocking portion 241T may be provided as a sliding block that moves according to the pulling of the traction element (not shown).

Referring to FIG. 50, the elastic element 294T according to the present disclosure will be specifically described.

The elastic element 294T is generally in a form of a sheet extending in the longitudinal direction. A clamping protrusion 294aT is disposed at the middle of the elastic element 294T in the longitudinal direction, so as to engage the elastic element 294T to the movable sliding frame 220T, which will be described in detail later.

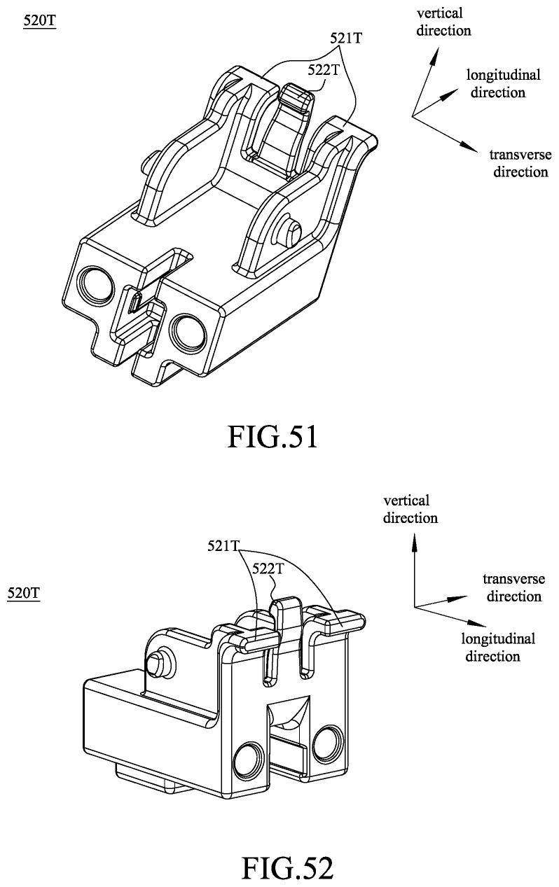

Referring to FIGS. 51 and 52, the mounting seat 520T according to the present disclosure will be described in detail.

The mounting seat 520T is generally rectangular, and the top of a longitudinal end (i.e., the front end) of the mounting seat 520T is provided with a limiting hook 522T and at least one contact bar 521T. In this embodiment, two contact bars 521T are arranged on two transverse sides of the mounting seat 520T and extend forward from a top end of the mounting seat 520T, respectively, thus forming a protruding shape extending outward in the longitudinal direction. The limiting hook 522T is disposed in the transverse middle of the mounting seat 520T and bent backward in the longitudinal direction, thus forming a hook-like shape extending inward in the longitudinal direction.

The mounting seat 520T is also provided with a structure for engaging the ground contacting indicator 101T, and since the ground contacting indicator 101T is not the focus herein, a detailed description of this structure is omitted herein.

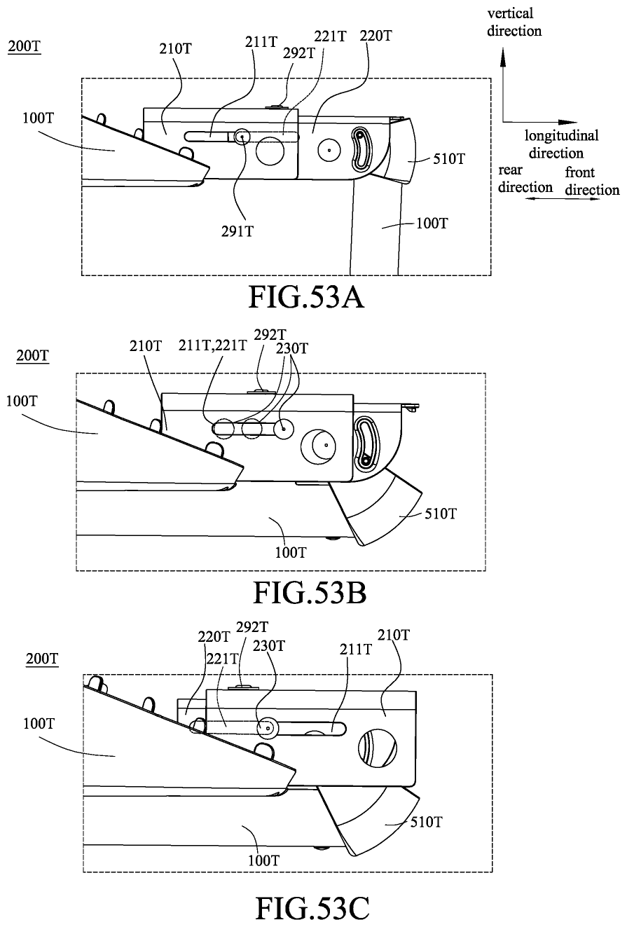

Referring to FIGS. 53A to 53C, the operation of the supporting leg telescopic mechanism 200T according to the present disclosure will be described.

As shown in FIG. 53A, the supporting leg telescopic mechanism 200T is in the extended state. The movable sliding frame 220T extends out of a longitudinal front of the fixed sliding frame 210T (i.e., the right side in FIG. 53A), so that the supporting leg 100T is located at a forward-most position. At this time, a front end of the fixed sliding groove 211T is overlapped with a rear end of the movable sliding groove 221T. The sliding pin 291T is located at the front end of the fixed sliding groove 211T, that is, at the rear end of the movable sliding groove 221T. Since the movable sliding frame 220T is located inside the fixed sliding frame 210T, an approximate position of the movable sliding groove 221T is indicated by a dotted line in FIG. 53A. It can also be seen in FIG. 53A that the limiting pin 292T is located at the front end of the fixed sliding frame 210T.

As shown in FIG. 53B, the supporting leg telescopic mechanism 200T is in a transitional state between the extended state and the retracted state. At this time, the movable sliding frame 220T is partially retracted to a position between the fixed sliding frames 210T in the longitudinal direction, and the movable sliding groove 221T and the fixed sliding groove 211T are at least partially overlapped in the longitudinal direction. The sliding pin 291T may be located at any position of the overlapping parts of the fixed sliding groove 211T and the movable sliding groove 221T, and dotted circles in FIG. 53B indicate possible positions of the sliding pin 291T.

It can also be seen from FIG. 53B that the limiting pin 292T is located between the fixed sliding frames 210T.

As shown in FIG. 53C, the supporting leg telescopic mechanism 200T is in the retracted state. The movable sliding frame 220T retracts to a longitudinal rear of the fixed sliding frame 210T (i.e., to the left side in FIG. 53C), so that the supporting leg 100T is located at a rear-most position. At this time, the rear end of the fixed sliding groove 211T is overlapped with the front end of the movable sliding groove 221T. The sliding pin 291T is located at the rear end of the fixed sliding groove 211T, that is, at the front end of the movable sliding groove 221T. Since the movable sliding frame 220T is located inside the fixed sliding frame 210T, the approximate position of the movable sliding groove 221T is indicated by a dotted line in FIG. 53C. It can also be seen in FIG. 53C that the limiting pin 292T is located at the rear end of the fixed sliding frame 210T.

As can be seen from FIGS. 53A to 53C, a stroke between the extended state and the retracted state of the supporting leg telescopic mechanism 200T is approximately equal to the sum of the lengths of the fixed sliding groove 211T and the movable sliding groove 221T. Therefore, the stroke may be larger than the length of the fixed sliding frame 210T or a length of the movable sliding frame 220T, thus increasing the possible expansion and retraction of the supporting leg 100T. The sliding pin 291T (i.e., the connecting element) is slidably connected to the fixed sliding frame 210T and the movable sliding frame 220T, respectively. A sliding direction of the sliding pin 291T with respect to the fixed sliding frame 210T is opposite to a sliding direction of the sliding pin 291T with respect to the movable sliding frame 220T during the supporting leg telescopic mechanism 200T is switched from the retracted state to the extended state.

In addition, although the supporting leg 100T is shown in the extended state in FIG. 53A and in the folded state in FIGS. 53B and 53C, it should be understood that the supporting leg 100T may be in the extended state or the folded state at any position shown in FIGS. 53A to 53C.

Referring to FIGS. 54A to 54C, the operation of the supporting leg telescopic mechanism 200T according to the present disclosure will be described continuously.

Through the cross-sectional views shown in FIGS. 54A to 54C, it can be more clearly seen that the positional relationship among the fixed sliding groove 211T, the movable sliding groove 221T and the sliding pin 291T changes with the movement of the movable sliding frame 220T. Specific changes refer to the previous description based on FIGS. 53A to 53C. The decorative cover 250T covers the movable sliding frame 220T and moves together with the movable sliding frame 220T. The locking element 240T moves in the longitudinal direction together with the movable sliding frame 220T, so that the locking element 240T can correspond to a plurality of longitudinal positions of the fixed sliding frame 210T. Under the condition that the fixed sliding frame 210T is provided with a plurality of first locking holes 215T in the longitudinal direction (see FIG. 46B), the locking element 240T can lock the movable sliding frame 220T in a plurality of longitudinal positions, including but not limited to the extended state and a completely locking state.

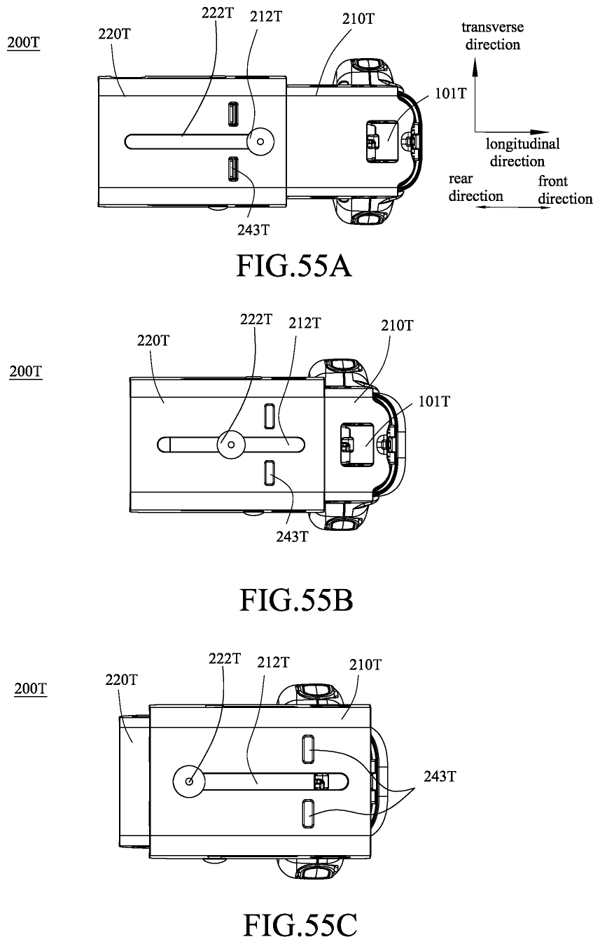

Referring to FIGS. 55A to 55C, the operation of the supporting leg telescopic mechanism 200T according to the present disclosure will be described continuously.

From the top views shown in FIGS. 55A to 55C, it can be clearly seen that the limiting pin 292T slides along the limiting groove 212T along with a movement of the movable sliding groove 221T, and moves to the rear end of the limiting groove 212T in the retracted state. In an embodiment in which the rear end of the limiting groove 212T is open (see FIG. 46B), when the supporting leg telescopic mechanism 200T is in the retracted state, the limiting pin 292T may be detached from the limiting groove 212T from the rear end of the limiting groove 212T. Therefore, it is possible to allow the supporting leg telescopic mechanism 200T to have a larger telescopic stroke under the condition that the fixed sliding frames 210T have the same length, or to allow the length of the fixed sliding frame 210T to be shortened under the condition that the supporting leg telescopic mechanisms 200T have the same telescopic stroke, so that the supporting leg telescopic mechanism 200T can save materials and reduce weight.

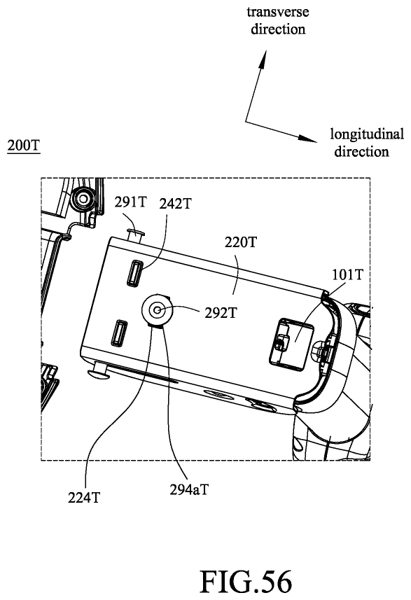

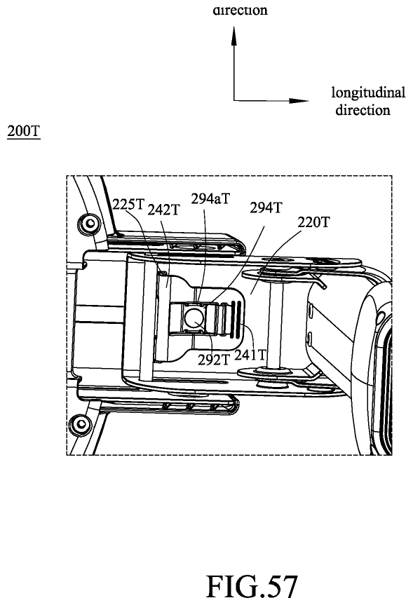

Referring to FIGS. 56 and 57, the arrangements of the locking element 240T and the elastic element 294T will be described.

As shown in the top view of FIG. 56, a top end of the movable sliding frame 220T is provided with the limiting pin 292T, and the notch 224T of the movable sliding frame 220T is provided at two transverse sides of the limiting pin 292T. The clamping protrusion 294aT of the elastic element 294T passes through a top surface of the movable sliding frame 220T from below and is engaged to the notch 224T.

As shown in the bottom view of FIG. 57, the locking element 240T is disposed on a lower surface of the top wall of the movable sliding frame 220T, the elastic element 294T is disposed under the locking element 240T, and the limiting pin 292T sequentially passes through the elastic element 294T, the locking element 240T and the top wall of the movable sliding frame 220T from bottom to top. Therefore, the limiting pin 292T assists in mounting the locking element 240T and the elastic element 294T to the movable sliding frame 220T. The locking protrusion 242T of the locking element 240T can pass through the second locking hole 225T on the top wall of the movable sliding frame 220T. In this embodiment, the locking element 240T and the elastic element 294T are disposed on the movable sliding frame 220T, and the locking element 240T can be engaged to the fixed sliding frame 210T to lock the relative position of the fixed sliding frame 210T and the movable sliding frame 220T.

An operation of the locking element 240T will be described referring to FIGS. 58A and 58B. A longitudinal center of the locking element 240T abuts against the top wall of the movable sliding frame 220T to form a fulcrum of a lever. In the locking state shown in FIG. 58A, the locking protrusion 242T is inserted into the first locking hole 215T of the fixed sliding frame 210T, and at this time, the movable sliding frame 220T is locked to the fixed sliding frame 210T. The user can push the unlocking portion 241T of the locking element 240T upward to pry the locking element 240T so that the locking protrusion 242T is detached from the first locking hole 215T, so that the locking element 240T is converted to the unlocking state shown in FIG. 58B, thereby allowing the movable sliding frame 220T to move relative to the fixed sliding frame 210T. The elastic element 294T is provided to bias the locking protrusion 242T towards the second locking hole 225T.

In an embodiment where the locking element 240T is mounted to the fixed sliding frame 210T, the locking protrusion 242T is inserted into the second locking hole 225T of the movable sliding frame 220T. The locking protrusion may be disengaged from the second locking hole 225T by the user's operation.

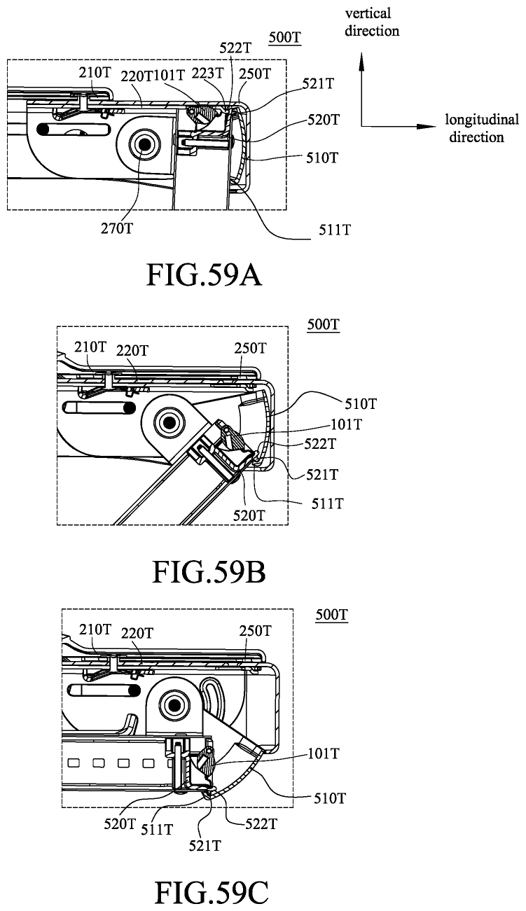

Referring to FIGS. 59A to 59C, the anti-pinch hand rotating mechanism 500T according to the present disclosure will be described in detail.

The anti-pinch hand rotating mechanism 500T includes an anti-pinch cover 510T and a mounting seat 520T. The anti-pinch cover 510T includes an arc-shaped surface extending around a transverse axis (see also FIG. 43). The anti-pinch cover 510T is disposed to rotate around the transverse axis, for example, around a transversely extending pivot shaft 270T. A lower end of the anti-pinch cover 510T has a step portion 511T extending towards an inner side (i.e., the longitudinal rear) of the anti-pinch cover 510T.

For a structure of the mounting seat 520T, please refer to related descriptions of FIG. 51 and FIG. 52.

The mounting seat 520T is disposed to rotate around the pivot shaft 270T along with the supporting leg 100T, and the decorative cover 250T can be driven by the supporting leg 100T or the mounting seat 520T to rotate.

When the supporting leg 100T is in the extended position shown in FIG. 59A, the anti-pinch cover 510T is located inside the decorative cover 250T, specifically, near an inner side of a front wall of the decorative cover 250T. That is, the decorative cover 250T is disposed on the supporting leg telescopic mechanism 200T and an accommodating space for accommodating the anti-pinch cover 510T is formed between the decorative cover 250T and the supporting leg telescopic mechanism 200T. The mounting seat 520T is located near the top wall of the decorative cover 250T, and the limiting hook 522T of the mounting seat 520T abuts against the clamping groove 223T of the movable sliding frame 220T to prevent the mounting seat 520T from continuously rotating upward (i.e. a counterclockwise direction in FIG. 59A). The limiting hook 522T may also be engaged with the clamping groove 223T to limit the supporting leg 100T in the extended position. The contact bar 521T of the mounting seat 520T is close to the top wall of the decorative cover 250T, so the contact bar 521T is near the top end of the anti-pinch cover 510T.

Starting from the extended position shown in FIG. 59A, when the user rotates the supporting leg 100T towards the folded position, the mounting seat 520T rotates downward (i.e., a clockwise direction in FIG. 59A) together with the supporting leg 100T.

When the supporting leg 100T is rotated by a first angle from the unfolded position shown in FIG. 59A, the supporting leg 100T is in an intermediate position shown in FIG. 59B. During the rotation from the unfolded position to the intermediate position, the contact bar 521T does not abut against the step portion 511T of the anti-pinch cover 510T, so the mounting seat 520T does not drive the anti-pinch cover 510T. When the supporting leg 100T rotates to the intermediate position and the contact bar 521T of the mounting seat 520T rotates to a bottom end of the anti-pinch cover 510T, the contact bar 521T abuts against the step portion 511T of the anti-pinch cover 510T.

Starting from the intermediate position shown in FIG. 59B, the supporting leg 100T and the mounting seat 520T continue to rotate downward (i.e., a clockwise direction in FIG. 59B) to reach the folded position shown in FIG. 59C. In the process of FIGS. 59B to 59C, the contact bar 521T abuts against a step portion 511T of the anti-pinch cover 510T, so that the anti-pinch cover 510T rotates downward together with the mounting seat 520T. The step portion 511T and the contact bar 521T may be shape-matched. A rotation angle from the unfolded position to the intermediate position may be called the first angle, and a rotation angle from the unfolded position to the folded position may be called the second angle. The second angle is larger than the first angle, for example, the first angle may be 30-60 degrees and the second angle may be 90 degrees, so a process of the supporting leg 100T rotating by the first angle is an idle stroke in which the anti-pinch cover 510T is not driven, thereby saving a storage space in the decorative cover 250T.

Referring to FIG. 59C, when the supporting leg 100T is rotated to the folded position, the mounting seat 520T is located at a position under the decorative cover 250T, and the anti-pinch cover 510T is rotated to a position between the mounting seat 520T and the decorative cover 250T, thus covering a gap between the mounting seat 520T and the decorative cover 250T. In this way, when the user moves the supporting leg 100T from the folded position to the extended position, a hand of the user will not be caught in the gap between the mounting seat 520T and the decorative cover 250T.

When the user moves the supporting leg 100T from the folded position to the extended position, the supporting leg 100T abuts against the bottom end of the anti-pinch cover 510T while the supporting leg 100T rotates counterclockwise in FIG. 59B, so as to drive the anti-pinch cover 510T to rotate counterclockwise and return to the extended position shown in FIG. 59A.

It should be understood that although the anti-pinch hand rotating mechanism 500T connected to the supporting leg telescopic mechanism 200T is described in the present disclosure, the anti-pinch hand rotating mechanism 500T may be installed at any suitable connecting portion between the supporting leg 100T and the body 300T. The anti-pinch cover 510T and the supporting leg 100T are pivoted on the same pivot shaft 270T. The pivot shaft 270T deviates from an extending line in a direction of the length of the supporting leg 100T, so that cooperation between the supporting leg 100T and the sliding frame is more compact.

Although preferred embodiments have been shown and described herein, it should be understood that these embodiments are only given as examples. Many modifications, changes and substitutions will be conceived by those skilled in the art without departing from the spirit of the present disclosure. Therefore, the appended claims are intended to cover all such modifications that fall within the spirit and scope of the present disclosure.

1-5. (canceled)

6. A carrier, comprising:
a base;
a supporting leg, pivotally connected to the base and configured to pivot relative to the base; and
a buffer mechanism, disposed between the base and the supporting leg and configured to contact at least one of the base and the supporting leg, wherein,
the buffer mechanism is configured to provide resistance to a pivoting movement of the supporting leg relative to the base,
wherein the supporting leg is configured to pivot between a folded position and an unfolded position, and the buffer mechanism comprises a buffer portion which provides resistance to a part route of pivoting of the supporting leg from the folded position to the unfolded position, and either:
the buffer portion is formed on the supporting leg, and in a process of the supporting leg moving from the folded position to the unfolded position, the buffer portion abuts against the base, so that the buffer portion is elastically deformed to prevent the pivoting of the supporting leg; or
the buffer portion is formed on the base, and in the process of the supporting leg moving from the folded position to the unfolded position, the buffer portion abuts against the supporting leg, so that the buffer portion is elastically deformed to prevent the pivoting of the supporting leg.

7. The carrier according to claim 6, wherein the carrier comprises a first cover portion and a second cover portion, wherein the first cover portion is disposed on the base, the second cover portion is pivotally connected to the base, and another buffer portion is formed on the second cover portion, wherein when the supporting leg moves from the folded position to the unfolded position, the supporting leg drives the second cover portion to pivot, and the another buffer portion abuts against the first cover portion during pivoting of the second cover portion, and at least one of the another buffer portion, the first cover portion and the second cover portion is formed of an elastic material.

8. The carrier according to claim 7, wherein the second cover portion is formed with deformation grooves on both sides of the another buffer portion, and a deformation space is defined between the another buffer portion and the supporting leg.

9. The carrier according to claim 6, wherein a protrusion is formed on the buffer portion, and another protrusion is formed on a cam of the supporting leg, the cam is configured to pivot about a pivot shaft of the supporting leg,
wherein, the another protrusion on the cam comprises a first protruding surface and a second protruding surface, the protrusion on the buffer portion is capable of contacting with the first protruding surface to prevent the pivoting of the supporting leg from the folded position to the unfolded position, and the protrusion on the buffer portion is capable of contacting with the second protruding surface to accelerate the pivoting of the supporting leg from the folded position to the unfolded position,
when the supporting leg is in the folded position, the first protruding surface is closer to the protrusion on the buffer portion than the second protruding surface.

10. The carrier according to claim 9, wherein the carrier further comprises an elastic element, which is connected to the supporting leg and configured to the supporting leg to a pivoting direction towards the unfolded position.

11. The carrier according to claim 6, wherein the base has a connecting portion pivotally connected to the supporting leg, and an accommodating space for accommodating the second cover portion is formed between the first cover portion and the connecting portion and the supporting leg, and when the supporting leg is in the unfolded position, the supporting leg is configured to push the second cover portion to pivot, so that the second cover portion is accommodated in the accommodating space;
the second cover portion is provided with a step portion, and an end of the supporting leg is provided with a contact bar protruding from the supporting leg, wherein when the supporting leg pivots from the unfolded position to the folded position, the contact bar pulls the step portion, so that the second cover portion pivots with the supporting leg to cover a gap between the supporting leg and the connecting portion.

12. The carrier according to claim 11, wherein the supporting leg has an intermediate position between the unfolded position and the folded position, and the contact bar does not abut against the step portion when the supporting leg pivots from the unfolded position to the intermediate position; and in the process of the supporting leg pivoting from the intermediate position to the folded position, the contact bar abuts against the step portion, so that the second cover portion pivots with the supporting leg.

13. A carrier, comprising:
a base, having a fixing bracket;
a movable bracket, slidably connected to the fixing bracket, the movable bracket is capable of sliding between an extended position and a retracted position;
a supporting leg, connected to the movable bracket;
a buffer mechanism, disposed between the base and the movable bracket and capable of contacting at least one of the base and the movable bracket; and
a restoring element, connected to the movable bracket and capable of biasing the movable bracket to a sliding direction away from the base.

14-26. (canceled)

27. The carrier according to claim 13, wherein the buffer mechanism comprises a buffer element formed as an elastic sheet, wherein an end of the buffer element is fixed in the base housing, and the buffer element is capable of abutting against the locking element to provide resistance to a part of the moving path of the supporting leg from the retracted position to the extended position.

28. The carrier according to claim 27, wherein the buffer mechanism comprises a locking element, wherein the fixing bracket is fixed in a base housing of the base, and the movable bracket is slidably disposed on the fixing bracket, and the locking element is protrudingly disposed on the movable bracket; and
the elastic sheet is formed with a protrusion for abutting against the locking element.

29. The carrier according to claim 28, wherein the protrusion includes a first surface and a second surface connecting the first surface, and an included angle between the second surface and the horizontal direction is greater than an included angle between the first surface and the horizontal direction; wherein, when the locking element abuts against the first surface, the buffer element applies a thrust force in a direction towards the retracted position to the locking element;
and when the locking element abuts against the second surface, the buffer element applies a thrust force in a direction towards the extended position to the locking element.

30. The carrier according to claim 13, wherein the buffer mechanism comprises a buffer element, one end of the buffer element is fixed to the movable bracket, and the other end of the buffer element is a free end, the free end partially abuts against the base housing to provide resistance to a movement of the movable bracket from the retracted position to the extended position.

31. The carrier according to claim 30, wherein the buffer element is configured to not abut against the base housing when the movable bracket is in the extended position thereof.

32. The carrier according to claim 30, wherein the free end of the buffer element extends upward and in the direction towards the extended position.

33. The carrier according to claim 30, wherein an inner side of the base housing is formed with a blocking concave portion and a blocking protrusion which are adjacent to each other, the free end of the buffer element is configured to sequentially abut against the blocking concave portion and the blocking protrusion in the process of the movable bracket moving from the retracted position to the extended position, thereby being subjected to increased resistance.

34. The carrier according to claim 6, wherein the buffer portion is formed as an elastic convex rib or a bent structural elastic sheet.

35. A carrier comprising:
a base that has a fixing bracket;
a movable bracket slidably connected to the fixing bracket thereof;
a supporting leg connected to the movable bracket;
a first buffer mechanism disposed between the movable bracket and the supporting leg, the first buffer mechanism configured to contact at least one of the movable bracket and the supporting leg;
a second buffer mechanism disposed between the base and the movable bracket, the second buffer mechanism configured to contact at least one of the base and the movable bracket; and
a restoring element that is connected to the movable bracket and configured to bias the movable bracket in a sliding direction away from the base;
wherein the supporting leg is configured to pivot between a folded position and an unfolded position, the first buffer mechanism includes a buffer portion, and the buffer portion provides resistance to a portion of a pivoting path of the supporting leg from the folded position to the unfolded position; and
the movable bracket is configured to slide between an extended position and a retracted position, and the second buffer mechanism is configured to provide resistance to a portion of a moving path of the movable bracket from the retracted position to the extended position.

36. The carrier according to claim 35, wherein the buffer portion is formed as an elastic convex rib or a bent structural elastic sheet.

37. The carrier according to claim 35, wherein the carrier comprises a first cover portion and a second cover portion, wherein the first cover portion is disposed on the base, the second cover portion is pivotally connected to the base, and the buffer portion is formed on the second cover portion, wherein when the supporting leg moves from the folded position to the unfolded position, the supporting leg drives the second cover portion to pivot, and the buffer portion abuts against the first cover portion during pivoting of the second cover portion, and at least one of the buffer portion, the first cover portion and the second cover portion is formed of an elastic material.

38. The carrier according to claim 35, wherein the second buffer mechanism comprises a buffer element formed as an elastic sheet, and either:
one end of the buffer element is fixed in the base housing, and the buffer element is capable of abutting against the locking element to provide resistance to a part of the moving path of the supporting leg from the retracted position to the extended position; or,
one end of the buffer element is fixed to the movable bracket, and the other end of the buffer element is a free end, the free end partially abuts against the base housing to provide resistance to a movement of the movable bracket from the retracted position to the extended position.
